(19) United States
(12) Patent Application Publication
(10) Pub. No.: US 2020/0190364 A1
(43) Pub. Date: Jun. 18, 2020

(54) RAPID CURING OF ADHESIVES ON A SUBSTRATE

(71) Applicant: Tomas Rey, El Paso, TX (US)

(72) Inventor: Tomas Rey, El Paso, TX (US)

(21) Appl. No.: 16/221,450

(22) Filed: Dec. 15, 2018

(51) Int. Cl. C09J 5/06; B32B 5/02; B32B 5/18; B32B 7/12; B32B 37/10; B32B 37/20

(52) U.S. Cl. CPC C09J 5/06; B32B 5/022; B32B 5/024; B32B 5/026; C09J 2400/263; B32B 7/12; B32B 37/10; B32B 37/203; C09J 2205/31; B32B 5/18

(57) ABSTRACT

A method and a lamination system including patterned coat rollers and a rapid curing chamber containing a serpentine draped roller system for rapidly curing a low viscosity, hot melt adhesive (LVHMA) coated on a substrate, for example, a foam sheet or a fabric material layer, are provided. A uniform dispersion of the LVHMA is applied on at least one surface of the substrate, where the patterned coat rollers create an imprinted pattern on the substrate for increasing absorption of the LVHMA into the substrate and preventing creeping of the LVHMA out of the substrate when the substrate is conveyed at a preset speed through the rapid curing chamber. The rapid curing chamber is set and maintained at a preset temperature and a preset humidity level based on the speed of conveyance of the coated substrate to rapidly cure the conveyed substrate in about 4 minutes to about 6 minutes.

### BACKGROUND

As used herein, a laminated product comprises a substrate with a bonding agent applied to one or more surfaces of the substrate to be laminated, with a laminate applied on the bonding agent to produce an in-process laminated product, which is thereafter cured in a curing chamber to produce the laminated product. Also, as used herein, an in-process laminated product refers to a substrate-bonding agent-laminated product prior to the curing of the substrate-bonding agent-laminated product in a curing chamber. An example of a substrate is a foam sheet, made for example from urethane, latex rubber, etc. An example of a laminate is a fabric material, for example, a cloth fabric, a knitted fabric, a woven fabric, a fiber bonded fabric made, for example, of a polyvinyl chloride (PVC) material, etc. An example of a bonding agent currently used in a foam lamination process is a thermoplastic, high viscosity, hot melt adhesive with a viscosity of about 12,000-14,000 centipoise (cps). An example of a laminated product is a fabric material laminate, bonded to a foam substrate on one and/or more surfaces of the foam substrate using a bonding agent, for example a hot melt adhesive with the fabric material-foam-hot melt adhesive in-process product cured in a curing chamber.

Conventional lamination processes comprise the following steps: applying a high viscosity, hot melt adhesive with, a viscosity of about 12,000 to about 14,000 cps at about 121° C., on the surface of the substrate to be laminated at an application range. for example, of about 75 grams per square inch to about 90 grams per square inch by roll coating or by spraying; applying the laminate to the high viscosity, hot melt adhesive coated substrate surface to be laminated by a coat roller; surface roller pressing the laminate and the substrate; and, thereafter curing the high viscosity, hot melt adhesive in the in-process laminated product by conveying the in-process laminated product at a relatively low speed of about 25 feet per minute or less through a cure chamber at about 121° C. and an ambient relative humidity for about 24-30 hours, to achieve the desired crosslinking of the thermoset high viscosity hot melt adhesive and effect the bonding of the laminate to the substrate.

High viscosity, hot melt adhesives are used in the conventional lamination process to prevent the foam sheet from completely absorbing and becoming saturated with the hot melt adhesive. Complete absorption of the hot melt adhesive in the foam sheet prevents adequate tack and causes the laminate, for example a fabric material layer to slide off the upper surface and/or the lower surface of, the foam sheet substrate, before the foam sheet substrate sandwiched between the fabric material laminate is press rolled between two surface rollers. The higher the viscosity of the hot melt adhesive, the higher is the crosslinking time required within the adhesive polymer to achieve the desired crosslinking of a thermoset adhesive and the higher is the cure time of the hot melt adhesive.

Furthermore, there is a need for a method that prevents creep and saturation of a bonding agent in the substrate, for example, a foam sheet High viscosity, hot melt adhesives typically used in the manufacture of foam laminates have a substantially high melt point of about 121° C. and are not as fluid in nature as a low viscosity hot melt adhesive. The high viscosity, hot melt adhesives are generally applied with a thicker coat, for example, at about 75 grams per square inch to about 90 grams per square inch onto the substrate, and the coated substrate run through surface rollers at a slow speed, for example, at about 25 feet per minute to ensure even disbursement of the high viscosity, hot melt adhesive over the surface of the substrate and laminate sheet at the melt point of the high viscosity, hot melt adhesive. However, even at the 121° C. melt point, the high viscosity, hot melt adhesives, may not get readily and fully absorbed into the substrate even after the substrate is pressed and surface rolled together with the laminate, for example a fabric material. Therefore, there is a need for increased absorption of the hot melt adhesive into the substrate, to prevent the hot melt adhesive from creeping out of the sandwiched substrate to ensure full usage of the hot melt adhesive for full bonding of the layers of the laminate to a substrate, and a need to reduce cure time.

The hot melt adhesive uses humidity of the ambient air as a catalyst to assist in crosslinking and curing process of the hot melt adhesive that is applied on the foam substrate. The bond strength and service temperature of the hot melt adhesive increases by formation of cross-links in the thermoplastic polymer as the thermoplastic polymer cures and solidifies. As the ambient temperature decreases, the humidity in the environment decreases which increases the cure time of a hot melt adhesive coated substrates. A change in the ambient temperature in the lamination processing area, changes the relative, humidity in the ambient environment which in turn affects the cure time and further affects the quality control of the finished laminate and slows the conventional lamination process. In general, in a lamination processing environment, the higher the ambient temperature, the more moisture the air can hold at a given temperature. Relative humidity is the ratio of the amount of moisture in the air versus how much moisture the air can hold. Therefore, there is a need to maintain a non-fluctuating ambient temperature in the lamination processing environment to ensure humidity at a preset level. Depending on the gram weight distribution of the hot melt adhesive on the substrate, conventional foam lamination processes take, for example, about 24 hours to about 30 hours to fully crosslink and cure the thermoset hot melt adhesive to a desirable level. Varying temperature and humidity levels in the lamination processing area requires a manufacturer to quality hold finished laminated products, typically for a period of, for example, about 24 hours to about 30 hours, after the lamination process is finished, to ensure an adequately cross-linked thermoset high viscosity adhesive and a proper bond strength of the laminate to the substrate. This results in a delay of shipment of the finished laminated products to customers. Therefore, there is a need for controlling the temperature and humidity of the in-process laminated product for maintain the quality of the laminated product and minimize quality control hold time of the finished laminated product.

Hence, there is along felt but unresolved need for a method and a system for rapidly curing a low viscosity, hot melt adhesive applied on a substrate to bond the laminate to the substrate, to produce high quality controlled laminated products in minimal time.

### SUMMARY OF THE INVENTION

This summary is provided to introduce a selection of concepts in a simplified form that are further disclosed in the detailed description of the invention. This summary is not intended to determine the scope of the claimed subject matter.

The method and the lamination system disclosed herein address the above recited need for rapidly curing a low viscosity, hot melt adhesive applied on a substrate to which a laminate layer, for example a fabric material layer, is bonded to an upper surface and a lower surface of the substrate by the low viscosity, hot melt adhesive.

A method of curing a low viscosity, hot melt adhesive with a viscosity in the range of about 4000 cps to 7000 cps is disclosed. The method comprises curing the low viscosity, hot melt adhesive at a preset temperature selected from a temperature range of about 70° C. to 90° C., at a preset humidity selected from a humidity range of about 20% to 95% relative humidity range, and a preset cure time of about 4 to 6 minutes.

A method for manufacturing a laminated product is disclosed. The method comprises applying a low viscosity, hot melt adhesive with a viscosity of about 4000 centipoises to about 7000 centipoises on the substrate surface to, be coated, at a hot melt adhesive application temperature selected from a temperature range of about 70° C. to about 121° C. The hot melt adhesive is applied on the substrate at a surface coating of about 15 grams per square inch to about 25 grams per square inch of the substrate. The method further comprises curing the in-process laminated product by conveying the in-process laminated product through a cure chamber maintained at a preset temperature selected from a temperature range of about 70° C. to about 90° C., at a preset humidity selected from a humidity range of about 20% to 95% relative humidity, and for a preset cure time of about 4 to 6 minutes, to achieve the desired crosslinking of the thermoset high viscosity hot melt adhesive and effect the bonding of the laminate to the substrate.

A method for rapidly curing a low viscosity, hot melt adhesive coated on a substrate is disclosed. The method comprises providing a lamination system comprising alignment rollers, an adhesive dispenser, patterned coat rollers, smooth surface rollers, conveyance rollers, and a rapid curing chamber. The rapid curing chamber comprises high intensity ultraviolet lamps, cold cooling stations, and a serpentine drape roller system. The serpentine drape roller system moves independently along a Y-axis. The method further comprises conveying the substrate on the alignment rollers of the lamination system using one or more of the conveyance rollers. The method further comprises applying a uniform dispersion of the low viscosity, hot melt adhesive on at least one surface of the conveyed substrate using the adhesive dispenser, one or more of the patterned coat rollers, and one or more of the smooth surface rollers of the lamination system to coat the at least one surface of the conveyed substrate. The one or more of the patterned coat rollers, in communication with the one or more of the smooth surface rollers, soften the conveyed substrate and create an imprinted pattern on the softened substrate for increasing absorption of the low viscosity, hot melt adhesive into the softened substrate and preventing creeping of the low viscosity, hot melt adhesive out of the softened substrate. The method further comprises applying a laminate layer on at least one surface of the coated surface of the softened substrate using one or more of the smooth surface rollers, one or more of the patterned coat rollers, and the one or more of the conveyance rollers of the lamination system to affix the laminate layer to the coated surface of the softened substrate. The method further comprises conveying the softened substrate with the affixed laminate layer through the serpentine drape roller system contained within the rapid curing chamber of the lamination system at a preset speed using the one or more of the conveyance rollers. wherein based on the preset speed of the conveyance of the softened substrate with the affixed laminate layer, the rapid curing chamber is maintained at a preset temperature and a preset humidity level different from ambient temperature and ambient humidity respectively to which the substrate and the material layer are exposed prior to entering the rapid curing chamber, using the high intensity ultraviolet lamps, and the cold, cooling stations in the rapid curing chamber. The method further comprises exposing the conveyed substrate with the affixed laminate layer to the preset temperature, the preset humidity level, and the preset speed in the rapid curing chamber for about 4 minutes to about 6 minutes to effect a rapid cure to create a laminated product where the lamination process is substantially free from emission of volatile organic compounds during the curing.

A lamination system for rapidly curing a low viscosity, hot melt adhesive coated on a substrate is disclosed. The lamination system comprises a material unwinder, in communication with one or more conveyance rollers, for conveying the substrate towards a plurality of alignment rollers of, the lamination system. The alignment rollers align, the conveyed substrate and create tension in the conveyed substrate. The lamination system further comprises an adhesive dispenser, in communication with one or more patterned coat rollers and one or more smooth surface rollers, for applying a uniform dispersion of the low viscosity, hot melt adhesive on at least one surface of the conveyed substrate to coat the at least one surface of the conveyed substrate. The one, or more of the patterned coat rollers, in communication with the one or more smooth surface rollers, soften the conveyed substrate and create an imprinted pattern on the softened substrate for increasing absorption of the low viscosity, hot melt adhesive into the softened substrate and to preclude creep of the low viscosity, hot melt adhesive out, of the softened substrate. The one or more smooth surface rollers and the one or more patterned coat rollers are in communication with the one or more conveyance rollers, for applying a laminate layer on the coated surface of the softened substrate to affix the laminate layer to the coated surface of the softened substrate. The lamination system further comprises a rapid curing chamber comprising high intensity ultraviolet lamps, cold cooling stations, and a serpentine drape roller system for receiving the softened substrate with the affixed laminate layer conveyed through the rapid curing chamber at a preset speed using the one or more conveyance rollers. Based on the preset speed of the conveyance of the softened substrate with the affixed laminate layer, the rapid curing chamber is set and maintained at a preset temperature and a preset humidity level different from ambient temperature and ambient humidity respectively to which the substrate and the laminate layer are exposed prior to entering the rapid curing chamber, using the high intensity ultraviolet lamps and the cold cooling stations in the rapid curing chamber. The rapid curing chamber rapidly cures the conveyed substrate with the affixed laminate layer exposed to the preset temperature, the preset humidity level, and the preset cure time of about 4 minutes to 6 minutes to create a laminated product, where the lamination process is substantially free from emission of volatile organic compounds during the curing.

A rapid curing chamber for rapidly curing a low viscosity, hot melt adhesive coated on a substrate is disclosed. The rapid curing chamber comprises high intensity ultraviolet lamps and cold cooling stations for setting and maintaining the rapid curing chamber at a preset temperature and a preset humidity level different from ambient temperature and ambient humidity respectively to which the substrate is exposed prior to entering the rapid curing chamber, based on speed of conveyance of the substrate. The rapid curing chamber further comprises drainage ports positioned at a lower location of the rapid curing chamber for draining liquids formed during the curing. The rapid curing chamber further comprises a serpentine drape roller system moving independently along a Y-axis for receiving, flexing, and stretching the substrate coated with the low viscosity, hot melt adhesive on at least one surface of the substrate and conveyed through the rapid curing chamber at a preset speed using the one or more conveyance rollers, and for rapidly curing the conveyed substrate exposed to the preset temperature, the preset humidity level, and the preset curing time in the rapid curing chamber of about 4 minutes to about 6 minutes to create a laminated product free from emission of volatile organic compounds during the curing.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 illustrates a method for manufacturing a laminated product by rapidly curing a low viscosity, hot melt adhesive coated on a substrate.

FIGS. 2A-2B exemplarily illustrate an embodiment of the method for rapidly curing a low viscosity, hot melt adhesive coated on both sides of a substrate.

FIGS. 3A-3B exemplarily illustrate another embodiment, of the method for rapidly curing a low viscosity, hot melt adhesive coated on, a substrate.

FIGS. 4A-4B exemplarily illustrate a lamination system for rapidly curing a low viscosity, hot melt adhesive coated on a substrate.

FIG. 5 exemplarily illustrates an enlarged view of a material unwinder in the lamination system for conveying a substrate towards multiple alignment rollers of the lamination system.

FIG. 6 exemplarily illustrates an enlarged view showing the alignment rollers in the lamination system for aligning the conveyed substrate to an adhesive dispenser, a patterned coat roller, and a smooth surface roller.

FIG. 7A exemplarily illustrates an enlarged view of an embodiment of a patterned coat roller, comprising a webbed pattern, for softening and creating an imprinted pattern on the conveyed substrate for increasing absorption of a low viscosity, hot melt adhesive into the softened substrate and preventing creep of the low viscosity, hot melt adhesive out from the softened substrate.

FIG. 7B exemplarily illustrates an enlarged view showing a webbed pattern of the patterned coat roller.

FIG. 7C exemplarily illustrates a photograph of the webbed pattern imprinted on the substrate coated with the low viscosity, hot melt adhesive.

FIG. 7D exemplarily illustrates an enlarged view of another embodiment of a patterned coat roller, comprising a hexagonal pattern.

FIG. 7E exemplarily illustrates an enlarged view of a hexagonal pattern of the patterned coat roller.

FIG. 7F exemplarily illustrates a photograph of the hexagonal pattern imprinted on the foam sheet coated with the hot melt adhesive.

FIG. 8 exemplarily illustrates an enlarged view showing application of a first laminate layer on one surface of the conveyed substrate.

FIG. 9A exemplarily illustrates an enlarged view of the conveyed substrate with the affixed first laminate layer.

FIG. 9B exemplarily illustrates a cross-sectional, view of a laminated product comprising the substrate with the affixed first laminate layer.

FIG. 10 exemplarily illustrates an enlarged view showing application of a second laminate layer on a coated opposing surface of a reversed substrate sheet.

FIG. 11A exemplarily illustrates an enlarged view of the conveyed substrate sandwiched between the affixed first laminate layer and an affixed second laminate layer.

FIG. 11B exemplarily illustrates a cross-sectional view of a laminated product comprising the substrate sandwiched between the affixed first laminate layer and the affixed second laminate layer.

FIG. 12 exemplarily illustrates an enlarged view showing a first route and a second route in the lamination system for sandwiching the conveyed substrate between the first laminate layer and the second laminate layer.

FIG. 13 exemplarily illustrates an enlarged view showing a material unwinder in the lamination system for unwinding the sandwiched substrate to a serpentine drape roller system contained within a rapid curing chamber of the lamination system.

FIG. 14 exemplarily illustrates an enlarged view of the rapid curing chamber comprising multiple high intensity ultraviolet lamps, cold cooling stations, drainage ports, and the serpentine roller system for rapidly curing the sandwiched substrate sheet.

FIG. 15 exemplarily illustrates an enlarged view showing a material upwinder in the lamination system for collecting the rapidly cured laminated product, wherein the lamination process is substantially free from emission of volatile organic compounds.

### DETAILED DESCRIPTION OF THE INVENTION

In the lamination process disclosed herein, a low viscosity, hot melt adhesive with a viscosity of about 4000 cps-7000 cps is applied at a gram weight disbursement of about 15 grams per square inch to about 25 grams per square inch of the substrate surface, on the substrate surface to be coated, at the low viscosity hot melt adhesive flow temperature selected from a temperature range of about 70° C. to 121° C. In an embodiment, the low viscosity, hot melt adhesive flow temperature is selected from a temperature range of about 70° C. to 90° C. The low viscosity hot melt adhesive, the viscosity of the low viscosity hot melt adhesive, the gram weight disbursement of the low viscosity hot melt adhesive applied on the substrate, and the temperature at which the low viscosity hot melt adhesive is applied on the substrate is selected based on the substrate and laminate used. Thereafter, the in-process laminated product is cured by conveying the in-process laminated product at a relatively high speed of about 25 meters per minute to about 60 meters per minute through a cure chamber maintained at a preset temperature selected from a temperature range of about 70° C. to 90° C., at a preset humidity level selected from a humidity range of about 20% to 95% relative humidity, for a preset cure time of about 4 minutes to 6 minutes, to achieve the desired crosslinking of the thermoset high viscosity hot melt adhesive and effect the bonding of the laminate to the substrate. The preset humidity in the cure chamber acts as a catalyst for curing the bonding agent.

In another embodiment of the lamination process disclosed herein, a low viscosity, hot melt adhesive with a viscosity of about 4000 cps-7000 cps, is applied to the substrate surface at a gram weight distribution of about 15 grains per square inch to about 25 grams per square inch of the substrate surface to be coated, at the hot melt adhesive flow temperature selected from a temperature range of about 70° C. to 121° C., depending on the substrate and laminate used to yield the in-process laminated product; thereafter, the in-process laminated product is cured by conveying the in-process laminated product at a relatively high speed of about 25 meters per minute to about 60 meters per minute through a cure chamber maintained at a preset temperature selected from a temperature range of about 70° C. to 90° C., and at a preset humidity level selected from a humidity range of about 20% to 95% relative humidity for about 4 to 6 minutes, to achieve the desired crosslinking of the thermoset high viscosity hot melt adhesive and effect the bonding of the laminate to the substrate. In an embodiment, cure chamber maintained at a preset temperature selected from a temperature range of about 70° C. to about 121° C. The preset humidity in the cure chamber acts as a catalyst for curing the bonding agent.

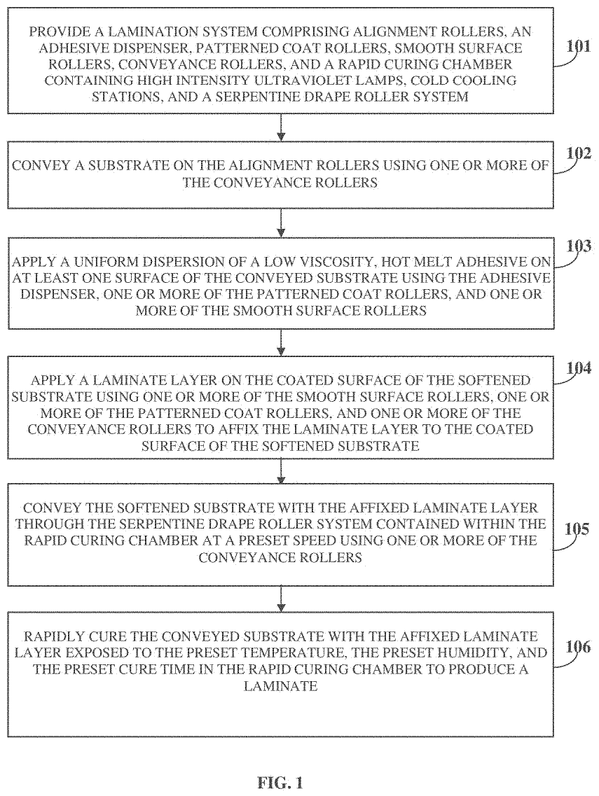

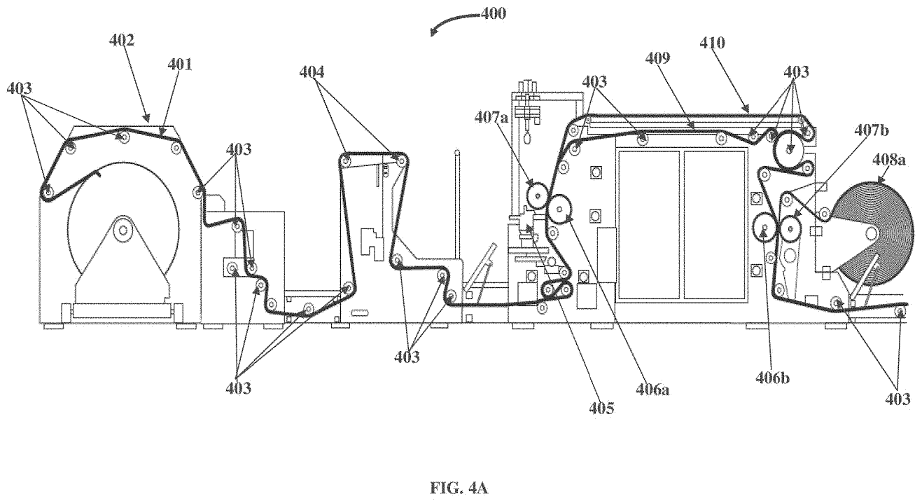

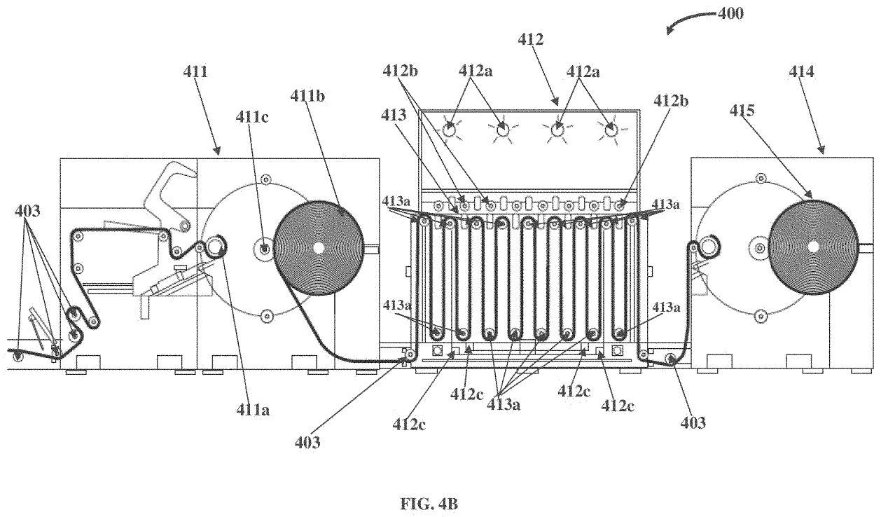

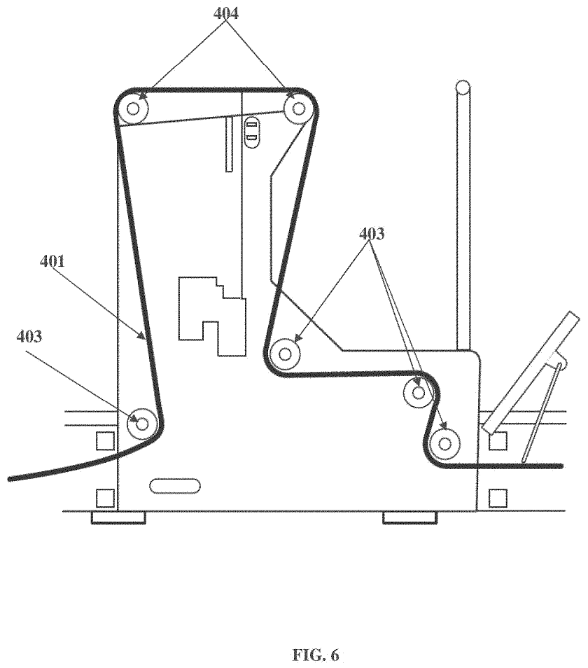

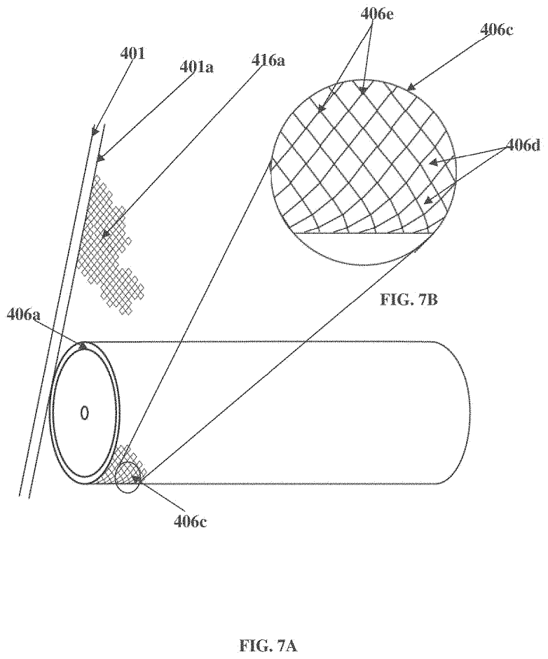

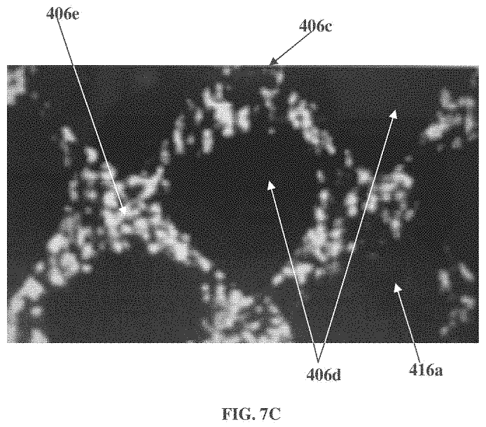

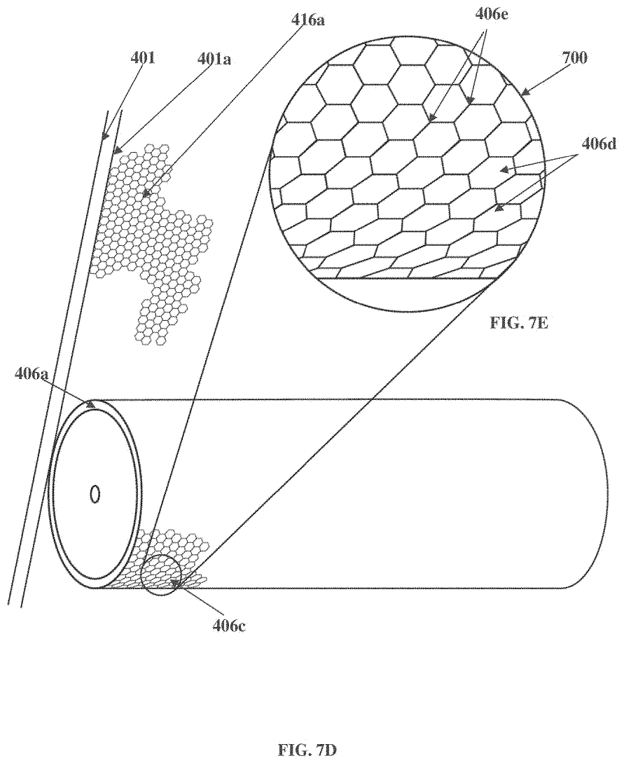

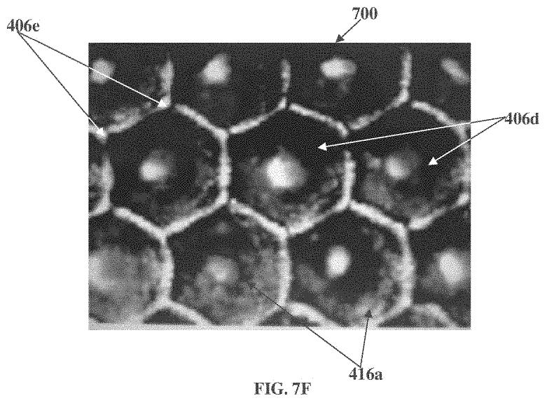

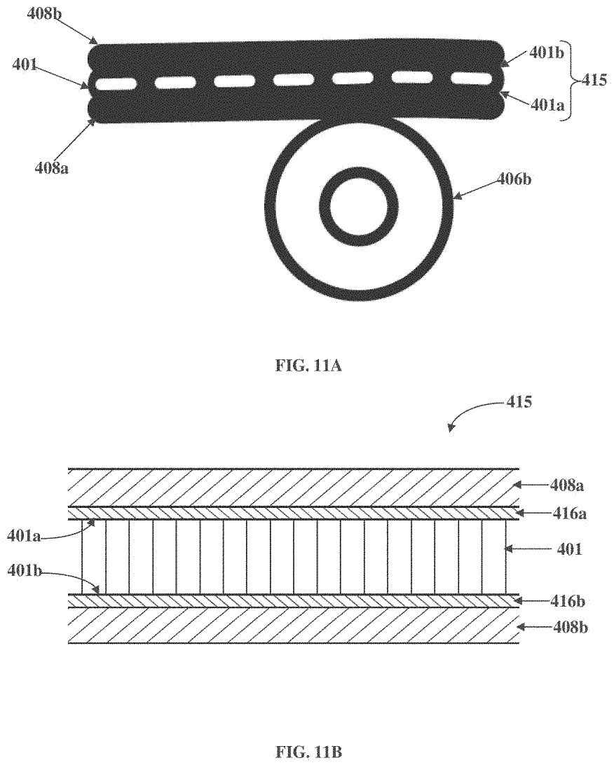

FIG. 1 illustrates a method for manufacturing a laminated product 217 by rapidly curing a low viscosity, hot melt adhesive 416a or 416b exemplarily illustrated in FIG. 7A, FIG. 7D and FIG. 11B, coated on a substrate, for example, a foam sheet 401 exemplarily illustrated in FIGS. 4A-4B. The method disclosed herein provides rapid cure of the low viscosity, hot melt adhesive 416a or 416b coated on the substrate, for example, foam sheet 401. The method disclosed herein is used, for example, in a foam to foam lamination process, a fabric to foam lamination process, a fabric to fabric lamination process, etc., for rapidly curing the low viscosity, hot melt adhesive 416a or 416b regardless of the substrate, for example, a foam sheet 401, a fabric material layer, etc., used. In the method disclosed herein, a lamination system 400 comprising alignment rollers 404, a low viscosity, hot melt adhesive dispenser 405, patterned coat rollers 406a and 406b, smooth surface rollers 407a and 407b, conveyance rollers 403, and a rapid curing chamber 412 as exemplarily illustrated in FIGS. 4A-4B, is provided 101. The rapid curing chamber 412 comprises multiple high intensity ultraviolet lamps 412a, cold cooling stations 412b, and a serpentine drape roller system 413. The serpentine drape roller system 413 moves independently along a Y-axis for conveying, flexing, and stretching the substrate to improve flexibility and draping properties of the laminated product 417 created therefrom. In the method disclosed herein, one or more conveyance rollers 403, convey 102 a substrate on the alignment rollers 404 of the lamination system 400. The substrate is, for example, a foam sheet 401, a fabric material, etc. The fabric material is, for example, any cloth, a knitted fabric, a woven fabric, a non-woven fabric, or a fiber bonded fabric. The substrate is, for example, a sheet of the substrate about 50 yards to about 450 yards long. The alignment rollers 404 align the conveyed substrate, for example, foam sheet 401 and create tension in the conveyed substrate for example, foam sheet 401.

The adhesive dispenser 405, in communication with one or more of the patterned coat rollers, for example, 406a, and one or more of the smooth surface rollers, for example, 407a, applies 103 a uniform dispersion of the low viscosity, hot melt adhesive 416a on at least one surface of the conveyed substrate, for example, a foam sheet 401 to coat at least one surface of the conveyed substrate for example, a foam sheet 401. The low viscosity, hot melt adhesive 416a or 416b is, for example, a low viscosity polyurethane hot melt adhesive of, for example, about 5000 centipoises (cps) to about 7000 cps applied to at least on one surface of the substrate, for example, a foam sheet 401, for example, at about 70° C. to about 121° C. In an example, the low viscosity, hot melt adhesive are Weiliche Pur2109, Weilche Pur2305, Weiliche Pur2353, Weilichhe Pur2358 and Weiliche Pur2565 of Wuxi Weiliche International Trade Co. Ltd. The patterned coat roller 406a, in communication with the smooth surface roller 407a, softens the conveyed substrate, for example, a foam sheet 401 and creates an imprinted pattern 406c exemplarily illustrated in FIG. 7A on the softened substrate, for example, on the softened foam sheet 401 exemplarily illustrated in FIGS. 7A-7F, for increasing absorption of the low viscosity, hot melt adhesive 416a into the softened substrate, for example, into the softened foam sheet 401 and to preclude creep of the low viscosity, hot melt adhesive 416a from the softened substrate, for example, from the softened foam sheet 401. The patterned coat roller 406a comprises, for example, a webbed pattern, a triangular pattern, a rhomboidal pattern, a hexagonal pattern etc., or any combination thereof. The conveyed substrate, for example, a foam sheet 401 is softened by pressing the conveyed substrate 401 between the patterned coat roller 406a and the smooth surface roller 407a. The created imprinted pattern 406c in the softened substrate sheet 401 comprises multiple channels 406d in the substrate, that allow the flow of the low viscosity, hot melt adhesive 416a in the substrate, thereby increasing the absorption of the low viscosity, hot melt adhesive 416a into the softened substrate and precluding creep of the low viscosity, hot melt adhesive 416a out of the softened substrate, for example, out of the softened foam sheet 401 as it is conveyed through the rapid curing chamber 412.

To preclude the low viscosity, hot melt adhesive 416a from creeping off the substrate, for example, the foam sheet 401 due to the liquidity of the low viscosity, hot melt adhesive 416a shown in FIG. 7A at the melt point of the low viscosity, hot melt adhesive 416a and prevent the substrate, for example, the foam sheet 401 from completely absorbing the low viscosity, hot melt adhesive 416a by saturation, the patterned coat roller 406a, for example, a webbed or triangle indented roller is used. By pressing the substrate, for example, the foam sheet 401 between the patterned coat roller 406a and the smooth surface roller 407a, channels 406d and high point impressions 406e are created in the substrate, for example, the foam sheet 401 thereby allowing the liquefied low viscosity, hot melt adhesive 416a to flow between high point impressions 406e created by the impressions 406c on the substrate, for example, the foam sheet 401 as exemplarily illustrated in FIGS. 7B-7D. The liquefied low viscosity, hot melt adhesive 416a creeps, i.e., runs through the channels 406d along a path of lowest resistance and contacts the base of the high point impressions 406e of the imprinted substrate, for example, the foam sheet 401. In the method disclosed herein, the low viscosity, hot melt adhesive 416a is sufficiently absorbed by the high point impressions 406e on the substrate, for example, the foam sheet 401 without complete saturation. For example, about 50 to 55% of the high point impressions 406e on the imprinted substrate, for example, the foam sheet 401 are saturated with the low viscosity, hot melt adhesive before actual lamination, and the remaining about 45 to 50% of the high point impressions 406e get wet with the low viscosity, hot melt, adhesive after being pressed by the patterned coat roller 406b.

The low viscosity, hot melt adhesive 416a is distributed on at least one surface of the conveyed substrate, for example, a foam sheet 401 in a preset and substantially uniform weight per gram distribution, for example, between about 15 grams per square inch to about 25 grams per square inch of the substrate sheet 401, dependent in part on the in-process laminated product layer between one or more of the smooth surface rollers 407a and 407b and one or more of the patterned coat rollers 406a and 406b of the lamination system 400. This preset and substantially uniform weight per gram distribution of the low viscosity, hot melt adhesive 416a on the substrate, for example, a foam sheet 401 allows the low viscosity, hot melt adhesive 416a to cure at a rapid cure rate with more crosslinking of low viscosity, hot melt adhesive polymer chains, thereby providing a strong bond and high temperature resistance of the low viscosity, hot melt adhesive 416a.

One or more smooth surface rollers for example, 407b, and one or more of the patterned coat rollers, for example, 406b, in communication with one or more of the conveyance rollers 403, apply 104 a laminate layer 408a on the low viscosity, hot melt adhesive coated surface of the softened substrate, for example, a foam sheet 401 to affix the laminate layer 408a to the coated surface of the softened substrate, for example, a foam sheet 401. The laminate layer 408a is, for example, a foam sheet, a fabric material layer, etc. The foam sheet 401 is, for example, a polyurethane foam sheet. The fabric material layer is, for example, a cloth, a knitted fabric, a woven fabric, a non-woven fabric, a fiber bonded fabric, etc. The patterned coat roller 406b comprises, for example, a webbed pattern, a triangular pattern, a rhomboidal pattern, a hexagonal pattern etc., or any combination thereof. The preset speed of conveyance of the substrate for example, a foam sheet 401 precludes saturation of the substrate, for example, a foam sheet 401 by the low viscosity, hot melt adhesive before application of the laminate layer 408a. One or more of the conveyance rollers 403 conveys 105 the softened substrate, for example, the softened foam sheet 401 with the affixed laminate layer 408a through the serpentine drape roller system 413 contained within the rapid curing chamber 412 of the lamination system 400 at a preset speed, for example, at a speed selected from about 25 meters per minute to about 60 meters per minute. The speed of conveyance of the softened substrate through the rapid curing chamber 412, for example, from about 25 meters per minute to about 60 meters per minute, precludes complete wetting or saturation of the softened substrate, for example, a foam sheet 401 with the liquefied, low viscosity, hot melt adhesive 416a. The laminate layer 408a is a sheet of the laminate material, for example, about 50 yards to about 450 yards long. The serpentine drape roller system 413 stretches and flexes the softened substrate, for example, a foam sheet 401 with the affixed laminate layer within the rapid curing chamber 412.

Based on the preset speed of conveyance of the softened substrate, for example, the softened foam sheet 401 with the affixed laminate layer 408a, the rapid curing chamber 412 is set and maintained at, a preset temperature selected from a temperature range, of, for example, from about 70° C. to about 90° C., and a preset humidity level selected from a humidity range of, for example, about 20% to about 95% relative humidity using the high intensity ultraviolet lamps 412a and the cold cooling stations 412b in the rapid curing chamber 412 respectfully; the preset temperature and humidity range may be different from ambient temperature and ambient humidity respectively to which the substrate, for example, the foam sheet 401 and the laminate layer 408a are exposed prior to entering the rapid curing chamber 412. In an embodiment, the preset temperature is selected from a temperature range from about 70° C. to about 90° C. The speed of conveyance of the softened substrate, for example, the foam sheet 401 with the affixed material layer 408a within the rapid curing chamber 412 is preset to preclude wetting or saturation of the softened substrate. The rapid curing chamber 412 rapidly cures 106 the conveyed substrate, for example, the foam sheet 401 with the affixed laminate layer 408a exposed to the preset temperature, the preset humidity level, at the preset conveyance speed of the in-process laminated product through the rapid curing chamber 412, to provide a preset cure time of about 4 minutes to 6 minutes to create a laminated product 417 wherein the lamination process is substantially free from emission of volatile organic compounds during the curing process. The created laminate 410 has improved bond strength, flexibility, and draping properties.

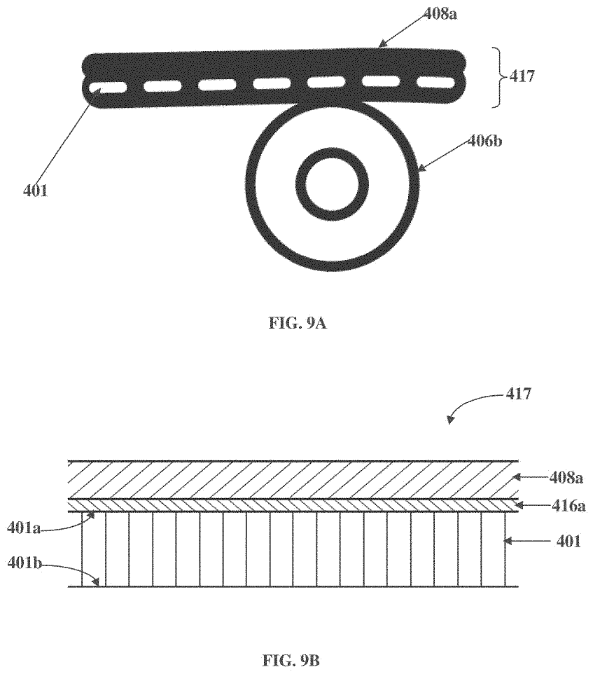

In an embodiment, after creation of the laminated product 417 as exemplary illustrated in FIG. 9A comprising the rapidly cured substrate, for example, a foam sheet 401 with an affixed laminate layer 408a on one surface of the substrate, for example, a foam sheet 401, the created laminated product 417 is reversed to expose the non-coated opposing surface 401b exemplarily illustrated in FIG. 9B of the created laminated product 417, and the reversed non-coated opposing surface 401b exemplarily illustrated in FIG. 9B of the laminated product 417 is conveyed on the alignment rollers 404 using one or more of the conveyance rollers 403. The adhesive dispenser 405, in communication with one or more of the patterned coat rollers, for example, 406a, and one or more of the smooth surface rollers, for example, 407a, applies a uniform dispersion of, the low viscosity, hot melt adhesive 416b on the exposed non-coated opposing surface 401b exemplarily illustrated in FIG. 9B of the reversed laminated product 417. The patterned coat roller 406a, in communication with the smooth surface roller 407a, softens the reversed laminated product 417 and creates an imprinted pattern on the softened laminated product 417 for increasing absorption of the low viscosity, hot melt adhesive 416b into the softened laminated product 417 to precludes creep of the low viscosity, hot melt adhesive 416a out of the softened laminated product 417. The created imprinted pattern in the softened laminated product 417 comprises multiple channels 406d along which the low viscosity, hot melt adhesive 416b flows, thereby increasing the absorption of the low viscosity, hot melt adhesive 416b into the softened laminated product 417 and to preclude creep of the low viscosity, hot melt adhesive 416b out from the softened laminated product 417 as the in-process laminated product 417 is conveyed through the rapid curing chamber 412.

One or more of the smooth surface rollers, for example, 407b, and one or more of the patterned coat rollers, for example, 406b, in communication with one or more of the conveyance rollers 403, apply a supplementary laminate layer 408b on the coated opposing surface of the softened substrate 417 exemplarily illustrated in FIG. 11A to affix the supplementary laminate 408b shown in FIG. 11B to the coated opposing surface 401b of the softened laminated product 417. The speed of conveyance of the softened laminated product 417 with the affixed supplementary laminate 408a precludes the softened laminated product 417 with the affixed laminate layer 408a from being saturated with the low viscosity hot melt adhesive before application of the supplementary laminate layer 408b. One or more of the conveyance rollers 403 convey the softened laminated product 417 with the affixed supplementary laminate layer 408b through the serpentine drape roller system 413 contained within the rapid curing chamber 412 of the lamination system 400 at a preset speed, for example, of about 25 meters per minute to about 60 meters per minute. Based on the preset speed of conveyance of the softened laminated product 417 with the affixed supplementary laminate layer 408b, the rapid curing chamber 412 is preset and maintained at a temperature selected from a temperature range of about 70° C. to about 90° C. and at a point just below substrate begins to soften, by the high intensity ultraviolet lamps 412a, and a preset humidity level selected from a humidity range of about 20% to about 95% relative humidity by the cold cooling stations 412b. In an embodiment, the rapid curing chamber 412 is preset and maintained at a temperature selected from a temperature range of about 70° C. to about 121° C. The environment in the rapid curing chamber 417 is different from the ambient temperature and ambient humidity to which the laminated product 417 and the supplementary laminate layer 408b are exposed prior to being conveyed through the rapid curing chamber 412. The rapid curing chamber 412 rapidly cures the conveyed in-process laminated product 417 with the affixed supplementary laminate layer 408b exposed to the preset temperature, the preset humidity level, and the preset transport speed in the rapid curing chamber 412, to provide a curing time selected from a curing time range, for example, of about 4 minutes to about 6 minutes, to create the laminated product, with the lamination process substantially free from volatile organic compounds during the curing process. In this embodiment, the substrate, for example, foam sheet 401 with the low viscosity, hot melt adhesives 416a and 416b undergoes two stages of rapid curing, where the first stage comprising rapid curing of the substrate 401 with the laminate layer 408a affixed to one surface 401a of the substrate, for example, foam sheet 401, and the second stage comprising rapid curing of the substrate, for example, foam sheet 401 with the supplementary laminate layer 408b affixed to an opposing surface 401b of the substrate, for example, foam sheet 401 exemplarily illustrated in FIG. 11B.

In another embodiment, prior to conveying the softened substrate, for example, foam sheet 401 with the affixed laminate layer 408a through the serpentine drape roller system 413 contained within the rapid curing chamber 412 at a preset speed using one or more of the conveyance rollers 403, the softened substrate with the affixed material layer 408a is reversed to expose a non-coated opposing surface 401b of the softened substrate sheet 401, and then the reversed substrate sheet 401 with the affixed material layer 408a is conveyed on the alignment rollers 404 using one or more of the conveyance rollers 403. The adhesive dispenser 405, in communication with one or more of the patterned coat rollers, for example, 406a, and one or more of the smooth surface rollers, for example, 407a, apply a uniform dispersion of the low viscosity, hot melt adhesive 416b on the exposed non-coated opposing surface of the reversed substrate 401. The patterned coat roller 406a, in communication with the smooth surface roller 407a, softens the reversed substrate, for example, foam sheet 401 and creates an imprinted channel pattern 406d on the softened substrate sheet 401 that allows the flow of the low viscosity, hot melt adhesive 416b cross the softened substrate sheet 401 thereby increasing absorption of the low viscosity, hot melt adhesive 416b into the softened substrate sheet 401 to preclude creep of the low viscosity, hot melt adhesive 416b out of the softened substrate sheet 401 into the rapid curing chamber 412. One or more of the smooth surface rollers, for example, 407b, and one or more of the patterned coat rollers, for example, 406b, in communication with one or more of the conveyance rollers 403, apply a supplementary laminate layer 408b exemplarily illustrated in FIG. 11A on the coated opposing surface 401b of the softened substrate 401 to affix the supplementary laminate layer 408b to the coated opposing surface of the softened substrate sheet 401. The laminate layers 408a and 408b are sequentially applied on opposing surfaces 401a, 401b exemplarily illustrated in FIG. 11A of the substrate sheet 401 to sandwich the substrate sheet 401 between the laminate layers 408a and 408b as exemplarily illustrated in FIGS. 11A-11B. The speed of conveyance of the in-process laminated product comprising the softened substrate sheet 401 with the affixed laminate layer 408a precludes the softened substrate sheet 401 with the affixed laminate layer 408a from being saturated with the low viscosity, hot melt adhesive before application of the supplementary material layer 408b on the surface of the softened substrate sheet 401. The softened substrate sheet 401 with the affixed laminate layer 408b on the coated surface 401a of the softened substrate sheet 401 and the affixed supplementary laminate layer 408b on the coated opposing surface 401b of the softened substrate 401 are conveyed through the serpentine drape roller system 413 contained within the rapid curing chamber 412 of the lamination system 400 for rapid curing. In this embodiment, the substrate 401 with the low viscosity, hot melt adhesives 416a and 416b undergo a single stage of rapid curing, where the single stage includes rapid curing of the substrate sheet 401 sandwiched between the laminate layers affixed to both surfaces of, the substrate 415 exemplarily illustrated in FIG. 11A

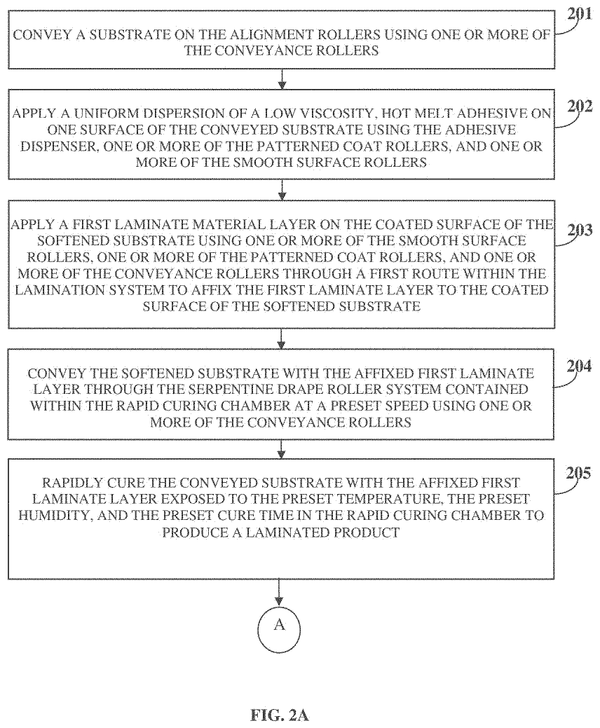

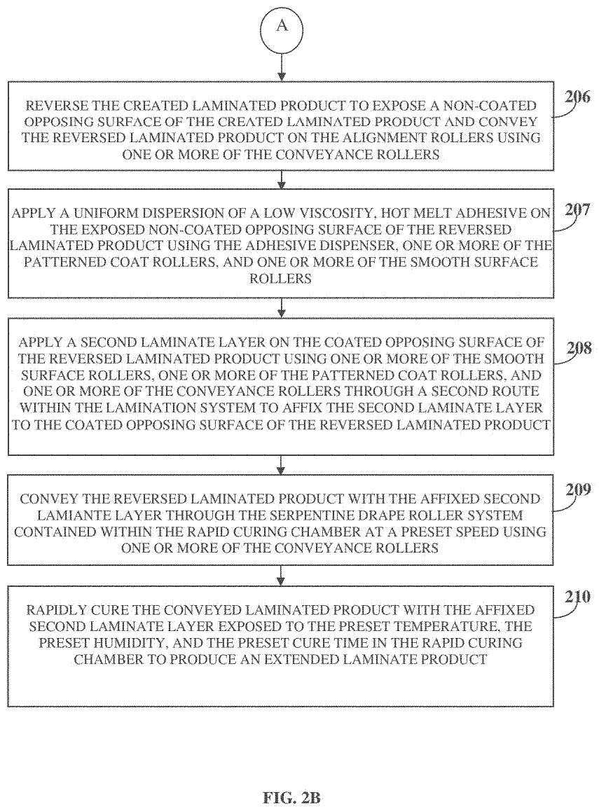

FIGS. 2A-2B exemplarily illustrate an embodiment of the method for rapidly curing a low viscosity, hot melt adhesive 416a or 416b exemplarily illustrated in FIG. 7A, FIG. 7D, and FIG. 11B, coated on a substrate, for example, a foam sheet 401. As exemplarily illustrated in FIGS. 2A-2B, the method disclosed herein provides a rapid cure of low viscosity, hot melt adhesives 416a and 416b applied to both the sides 401a, 401b of the substrate sheet 401 exemplarily illustrated in FIG. 11B, in contrast to curing of the low viscosity, hot melt adhesives 416a adhesive applied to one surface 401a of the foam sheet 401 as disclosed in the detailed description of FIG. 1. In the method disclosed herein, the lamination system 400 comprising the alignment rollers 404 the adhesive dispenser 405, the patterned coat rollers 406a and 406b, the smooth surface rollers 407a and 407b, the conveyance rollers 403 positioned for lamination through a first route 409 and a second route 410, and the rapid, curing chamber 412 containing multiple high intensity ultraviolet lamps 412a, cold cooling stations 412b, and the serpentine drape roller system 413 as exemplarily illustrated in FIGS. 4A-4B, is provided. A substrate, for example a foam sheet 401 as exemplarily illustrated in FIGS. 4A-4B, is conveyed 201 on the alignment rollers 404 using one or more of the conveyance rollers 403. The foam sheet 401 is, for example, a sheet of polyurethane foam about 50-450 yards long. The alignment rollers 404 align and create tension in the conveyed substrate, for example, foam sheet 401 prior to coating one or more surfaces 401a and 401b of the conveyed substrate, foam sheet 401 exemplarily illustrated in FIG. 11B, with a low viscosity, hot melt adhesive 416a or 416b.

A low viscosity, hot melt adhesive 416a is heated to its melting temperature, for example, at about 121° C. and applied 202 on one surface 401a, for example, an upper surface of the conveyed substrate, for example, foam sheet 401 using the adhesive dispenser 405 one or more patterned coat rollers, for example, 406a, and one or more smooth surface rollers, for example, 407a, of the lamination system 400, to coat the upper surface 401a of the conveyed substrate sheet 401 with a uniform coating, for example, about 15 grams per square inch to about 25 grams per square inch of the low viscosity low melt adhesive as illustrated in FIGS. 4A and 4B. The patterned coat roller 406a softens the conveyed substrate sheet 401 by pressing the conveyed substrate sheet 401 against a smooth surface of the smooth surface roller 407a. The patterned coat roller 406a in communication with the smooth surface roller 407a creates an imprinted pattern on the softened substrate sheet 401 for increasing absorption of the low viscosity, hot melt adhesive 416a into the softened substrate sheet 401 and to preclude creep of the low viscosity, hot melt adhesive 416a out of the softened foam sheet 401.

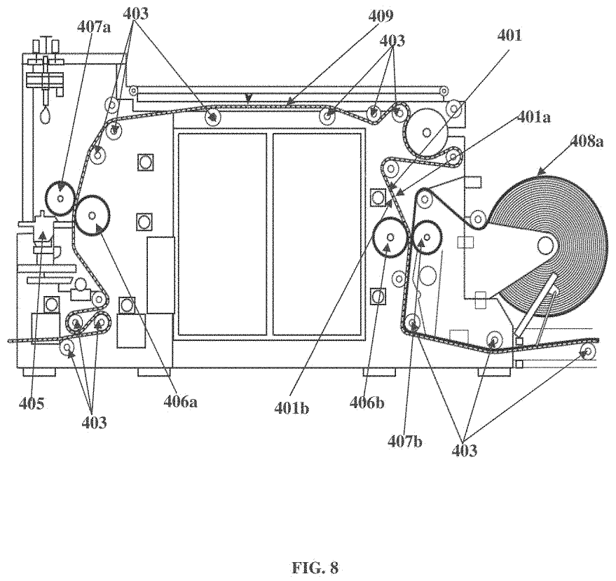

A first laminate layer 408a, for example a fabric layer between about 50 yards and 450 yards is applied 203 on the coated surface 401a of the softened substrate sheet 401 using one or more of the smooth surface rollers, for example, 407b, one or more of the patterned coat rollers, for example, 406b, and one or more of the conveyance rollers 403 of the lamination system 400 through a first route 409 within the lamination system 400 to affix the first laminate layer 408a to the coated surface 401a of the softened substrate sheet 401 as exemplarily illustrated in FIGS. 8-9. As exemplarily illustrated in FIGS. 4A-4B, one or more of the conveyance rollers 403 convey 204 in-process laminated product comprising the softened substrate sheet 401 with the affixed first laminate layer 408a through the serpentine drape roller system 413 contained within the rapid curing chamber 412 at a preset speed, for example, from about 25 meters per minute to about 60 meters per minute to provide a conveyance time for the in-process laminated product through the curing chamber at about 4 to 6 minutes. The rapid curing chamber 412 is set and maintained at a preset temperature, for example, at a temperature selected from a temperature range of about 70° C. to about 90° C., and at a preset humidity selected from a humidity range of, for example, about 20% to about 95% relative humidity, using the high intensity ultraviolet lamps 412a and the cold cooling stations 412b in the rapid curing chamber 412 as exemplarily illustrated in FIG. 4B. The preset temperature and the preset humidity level of the rapid curing chamber 412 are different from the ambient temperature and ambient humidity respectively to which the substrate, for example, foam sheet 401 and the first laminate layer 408a are exposed prior to entering the rapid curing chamber 412. The rapid curing chamber 412 rapidly cures 205 the conveyed substrate sheet 401 with the affixed first laminate layer 408a exposed to the preset temperature, the preset humidity level, and the preset speed and the preset time in the rapid curing chamber 412, to create a laminated product 417 exemplarily illustrated in FIG. 9B, with the lamination process substantially free from emission of volatile organic compounds during the curing process.

In this embodiment, after creation of the laminated product 417 by rapidly curing 205 the conveyed substrate, for example, foam sheet 401 with the affixed first laminate layer 408a, the created laminated product 417 is reversed 206 to expose the second non-coated opposing surface 401b, for example, a lower surface of the created laminated product 417 exemplarily illustrated in FIG. 9B, and then the reversed laminated product 417 is conveyed on the alignment rollers 404 using one or more of the conveyance rollers 403. A uniform dispersion of, for example, about 15 grams per square inch to about 25 grams per square inch, of the low viscosity, hot melt adhesive 416b is applied 207 on the exposed second non-coated opposing surface 401b of the reversed laminated, product 417 using the adhesive dispenser 405, one or more of the patterned coat rollers, for example, 406a, and one or more of the smooth surface rollers, for example, 407a, to coat the exposed non-coated opposing surface 401b of the reversed laminated product 417. The patterned coat roller 406a, in communication with the smooth surface roller 407a, softens the reversed laminated product 417 and creates an imprinted pattern on the softened laminated product 417 for increasing absorption of the low viscosity, hot melt adhesive 416b into the softened laminate product 417 to preclude creep of the low viscosity, hot melt adhesive 416b out of the softened laminated product 417. In an embodiment, the exposed non-coated opposing surface 401b of the reversed laminated product 417 is coated with the same low viscosity hot melt adhesive 416b, at the same weight per gram distribution as that of the coated surface 401a of the substrate, for example, foam sheet 401 to ensure proper wetting of the laminate product 417 for curing and to provide the desired cross linking of the low viscosity, hot melt adhesive 416b between the substrate, sheet 401, the first laminate layer 408a, and a second laminate layer 408b when the in process laminated product 417 affixed with the second laminate layer 408b is conveyed through the rapid curing chamber 412.

A supplementary laminate layer, for example, a second laminate layer 408b, for example a fabric material layer is then applied 208 on the coated opposing surface 401b of the reversed laminated product 417 conveyed through one or more of the conveyance rollers 403 through the second route 410 within the lamination system 400 using one or more of the smooth surface rollers, for example, 407b, and one or more of the patterned coat rollers, for example, 406b, to affix the second laminate layer 408b to the coated opposing surface 401b of the reversed laminated product 417 as exemplarily illustrated in FIG. 11B. The second laminate layer 408b is a sheet of, for example, cloth, or a knitted fabric, or a woven fabric, or a non-woven polyester material, foam, a polyvinyl chloride material, etc., or any combination thereof, between about 50 yards and about 450 yards long.

The reversed laminated product 417 with the affixed second laminate layer 408b is conveyed 209 through the serpentine drape roller system 413 contained within the rapid curing chamber 412 at a preset speed, for example, a speed selected from about 25 meters per minute to about 60 meters per minute to provide a preselected curing time in the curing chamber from about 4 minutes to 6 minutes, using one or more of the conveyance rollers 403. Based on the preset speed of conveyance of the reversed foam laminate 417 with the affixed second laminate layer 408b, the rapid curing chamber 412 is set and maintained at a preset temperature selected from a temperature range of about 70° C. to about 90° C., and a preset humidity selected from a humidity range of about 20% to about 95% relative humidity, using the high intensity ultraviolet lamps 412a and the cold cooling stations 412b in the rapid curing chamber 412. The preset temperature and the preset humidity level of the rapid curing, chamber 412 are different from ambient temperature and ambient humidity respectively to which the reversed laminate product 417 and the second laminate layer 408b are exposed prior to entering the rapid curing chamber 412. The rapid curing chamber 412 rapidly cures 210 the conveyed laminated product 417 with the affixed second laminate layer 408b exposed to the preset temperature, the preset humidity level, and the preset speed in the rapid curing chamber 412, for example, in about 4 minutes to about 6 minutes to create an extended laminate free from emission of volatile organic compounds during the curing process.

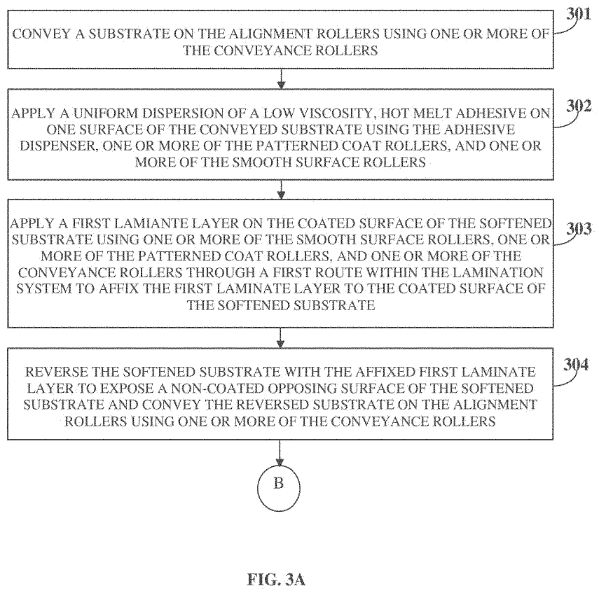

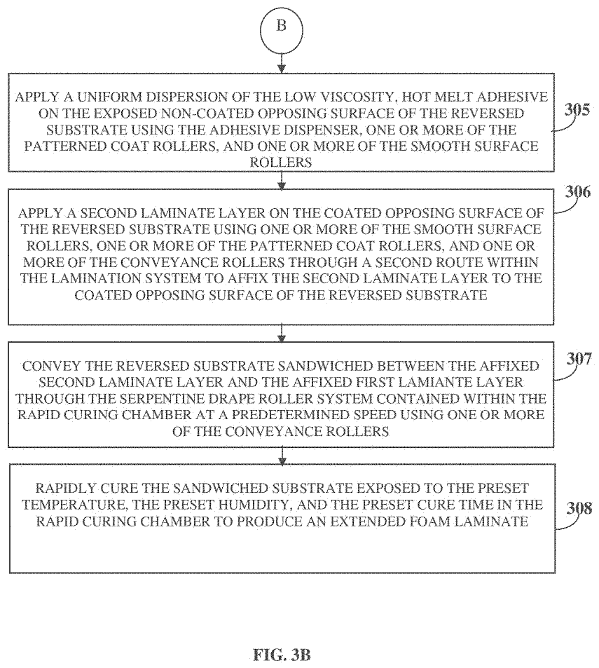

FIGS. 3A-3B illustrate another embodiment of the method for rapidly curing a low viscosity, hot melt adhesive 416a or 416b exemplarily illustrated in FIG. 7A and FIG. 11B, coated on a substrate, for example, foam sheet 401 exemplarily illustrated in FIGS. 4A-4B. In this embodiment, the substrate, for example, foam sheet 401 with the low viscosity, hot melt adhesives 416a and 416b undergoes a single stage of rapid curing, where the single stage includes rapid curing of the substrate, for example, foam sheet 401 sandwiched between the laminate layers 408a, 408b affixed to both surfaces of the extended foam laminate 415, in contrast to the two separate stages of curing, i.e., curing of the laminate product 417 and the extended laminated product separately as disclosed in the detailed description of FIGS. 2A-2B. The lamination system 400 comprising the alignment rollers 404, the adhesive dispenser 405, the patterned coat rollers 406a and 406b, the smooth surface rollers 407a and 407b, the conveyance rollers 403 positioned for lamination through a first route 409 and a second route 410, and a rapid curing chamber 412 containing the high intensity ultraviolet lamps 412a, the cold cooling stations 412b, and the serpentine drape roller system 413 exemplarily illustrated in FIGS. 4A-4B is provided.

In this embodiment, the method disclosed herein comprises (a) conveying 301 a substrate, for example, foam sheet 401 on the alignment rollers 404 using one or more of the conveyance rollers 403; (b) applying 302 a uniform dispersion of a low viscosity, hot melt adhesive 416a on one surface 401a of the conveyed substrate, for example, foam sheet 401 exemplarily illustrated in FIG. 7A, using the adhesive dispenser 405, one or more of the patterned coat rollers, for example, 406a, and one or more of the smooth surface rollers, for example, 407a, to coat one surface 401a of the conveyed substrate, for example, foam sheet 401; (c) applying 303 a laminate layer, for example a first laminate layer 408a on the coated surface 401a of the softened substrate, for example, foam sheet 401 using one or more of the smooth surface rollers, for example, 407b, one or more of the patterned coat rollers, for example, 406b, and one or more of the conveyance rollers 403 through a first route 409 within the lamination system 400 to affix the first laminate layer 408a to the coated surface 401a of the conveyed substrate, for example, foam sheet 401; (d) reversing 304 the softened substrate, for example, foam sheet 401 with the affixed first laminate layer 408a to expose a non-coated opposing surface 401b of the softened substrate, for example, foam sheet 401 exemplarily illustrated in FIG. 11B, and conveying the reversed substrate, for example, foam sheet 401 on the alignment rollers 404 using one or more of the conveyance rollers 403; (e) applying 305 a uniform dispersion of the low viscosity, hot melt adhesive 416b on the exposed non-coated opposing surface 401b of the reversed substrate, for example, foam sheet 401 using the adhesive dispenser 405, one or more of the patterned coat rollers, for example, 406a, and one or more of the smooth surface rollers, for example, 407b to coat the exposed non-coated opposing surface 401b of the reversed substrate sheet 401; (f) applying 306 a supplementary laminate layer, for example, a second laminate layer 408b on the coated opposing surface 401b of the reversed substrate, for example, foam sheet 401 through the second route 410 within the lamination system 400 using one or more of the smooth surface rollers, for example, 407b, one or more of the patterned coat rollers, for example, 406b, and one or more of the conveyance rollers 403 to affix the second laminate layer 408b to the coated opposing surface 401b of the reversed substrate, for example, foam sheet 401; (g) conveying 307 the reversed substrate sheet 401 sandwiched between the affixed second laminate layer 408b and the affixed first laminate layer 408a through the serpentine drape roller system 413 contained within the rapid curing chamber 412 of the lamination system 400 at a preset speed using one or more conveyance rollers 403; and (h) rapidly curing 308 the conveyed substrate, for example, foam sheet 401 sandwiched between the affixed second laminate layer 408b and the affixed first laminate layer 408a exposed to the preset temperature, the preset, humidity level, and the preset speed in the rapid curing chamber 412, to provide a preselected cure time in the curing chamber from about 4 minutes to 6 minutes to create an extended foam laminate 415 wherein the lamination process is substantially free from emission of volatile organic compounds during the curing process as disclosed in the detailed description of FIGS. 4A-4B.

In the methods disclosed in the detailed descriptions of FIGS. 2A-2B and FIGS. 3A-3B, laminated product 417 and extended foam laminate 415 of enhanced bond strengths combined with good drape and flexibility are created by, using optimally formulated low viscosity, hot melt adhesives 416a and 416b. Specific properties required for different applications are built into the low viscosity, hot melt adhesives 416a and 416b by the use of a variety of polyols, isocyanates, and additives. Polyols, for example, crystalline polyesters or amorphous polyesters are used to vary an open time, a set time, and the ability to wet various surfaces of the conveyed substrate, for example, foam sheet 401 to improve bond strength of the sandwiched substrate, for example, foam sheet 401 with the affixed first laminate layer 408a and the affixed second laminate layer 408b. “Open time” refers the time after the application of the low viscosity, hot melt adhesive 416a or 416b but before, the low viscosity, hot melt adhesive 416a or 416b has dried to a point where the low viscosity, hot melt adhesive 416a or 416b is no longer wet to improve the bond strength of the substrate, for example, foam sheet 401 sandwiched between the affixed first laminate layer 408a and the affixed second laminate layer 408b. “Set time” refers to the time, the low viscosity, hot melt adhesive 416a or 416b takes to form an acceptable bond between the sandwiched substrate, for example, foam sheet 401. The crystalline polyesters when used as low viscosity, hot melt adhesives 416a and 416b provide short set times and creates rapid green-strength development, that is, the crystalline polyesters create early development of bond strength of the low viscosity, hot melt adhesives 416a and 416b between the sandwiched substrate, for example, foam sheet 401, the first fabric material layer 408a and the second fabric material layer 408b. The amorphous polyesters when used as low viscosity, hot melt adhesives 416a and 416b improve adhesion to specific substrates and increase the open time of the low viscosity, hot melt adhesives 416a and 416b. Polyethers which are amorphous liquids having a low glass-transition temperature when used as the low viscosity, hot melt adhesives 416a and 416b lengthen the open time, reduces viscosity, and provides good low temperature flexibility of the extended foarn laminate 415. The glass transition is temperature in which the polymer from a hard and a relatively brittle glassy state is transferred into a viscous or rubbery state when the temperature is increased. Vinyl-polymerized polyols which are typically high molecular weight, glassy solids assist in building green strength and tack of the sandwiched substrate, for example, foam sheet 401 with the first laminate layer 408a and the second laminate layer 408b while maintaining extended open times. The temperature and viscosity of the low viscosity, hot melt adhesives 416a and 416b are not set substantially high. For example, the temperature is selected from a temperature range of about 70° C. to about 121° C., and although the viscosity is substantially low, for example, about 4000 cps to about 7000 cps, the coating weight is evenly distributed by using the patterned coat roller 406a configured, for example, in triangular and/or webbed shapes.

FIGS. 4A-4B exemplarily illustrate the lamination system 400 for rapidly curing a low viscosity, hot melt adhesive 416a or 416b exemplarily illustrated in FIG. 7A and FIG. 11B, coated on a substrate, for example, a foam sheet 401. The lamination system 400 comprises material unwinders 402 and 411, the alignment rollers 404, the adhesive dispenser 405, the patterned coat rollers 406a and 406b, the smooth surface rollers 407a and 407b and the conveyance rollers 403 positioned for lamination through the first route 409 and the second route 410, the rapid curing chamber 412, and a material upwinder 414 as exemplarily illustrated in FIGS. 4A-4B. The first route 409 is a lower pathway in the lamination system 400 through which the substrate, for example, foam sheet 401 coated with the low viscosity, hot melt adhesive 416a is conveyed, for bonding the first laminate layer 408a, for example, a fabric layer to the coated upper surface 401a of the substrate, for example, foam sheet 401 exemplarily illustrated in FIG. 9B. The second route 410 is an upper pathway in the lamination system 400 through which the substrate, for example, foam sheet 401 with the exposed lower surface 401b exemplarily illustrated in FIG. 11B, coated with the low viscosity, hot melt adhesive 416b is conveyed for bonding the second laminate layer 408b to the coated lower surface 401b of the substrate, for example, foam sheet 401. The first route 409 is positioned below the second route 410 as exemplarily illustrated in FIG. 4A. The material unwinders 402 and 411 and the material upwinder 414 are used for material handling ease and for transition of the substrate, for example, foam sheet 401 to different stages of the lamination process. The material unwinder 402, in communication with one or more of the conveyance rollers 403, conveys a substrate, for example, foam sheet 401 towards the alignment rollers 404. The alignment rollers 404 align the conveyed substrate, for example foam sheet 401 and create tension on the aligned substrate, for example, foam sheet 401 prior to coating one or more surfaces 401a and 401b of the conveyed substrate, for example, foam sheet 401 with the low viscosity, hot melt adhesives 416a and 416b.

The alignment rollers 404, in communication with one or more of the conveyance rollers 403, convey the aligned substrate, for example foam sheet 401 between the patterned coat roller 406a and the smooth surface roller 407a. The adhesive dispenser 405, in communication with the patterned coat roller 406a and the smooth surface roller 407a applies a uniform dispersion of a low viscosity, hot melt adhesive 416a exemplarily illustrated in FIG. 7A, on one surface 401a of the aligned substrate, for example, foam sheet 401 to coat the surface 401a of the aligned substrate, for example, foam sheet 401. The patterned coat roller 406a presses the aligned substrate, for example, foam sheet 401 against the smooth surface roller 407a to soften the aligned substrate, for example, foam sheet 401 and create an imprinted pattern on the softened substrate, for example, foam sheet 401 for increasing absorption of the low viscosity, hot melt adhesive 416a into the softened substrate, for example, foam sheet 401 to preclude creep of the low viscosity, hot melt adhesive 416a out of the softened substrate, for example, foam sheet 401.

One or more of the conveyance rollers 403 convey the softened substrate, for example, foam sheet 401 with one surface 401a coated with the low viscosity, hot melt adhesive 416a towards the smooth surface roller 407b and the patterned coat roller 406b. The smooth surface roller 407b and the patterned coat roller 406b, in communication with, one or more of the conveyance rollers 403, roll and press a first laminate layer 408a on one surface 401a of the softened substrate, for example, foam sheet 401 through the first route 409 within the lamination system 400 to affix the first laminate layer 408a to the coated surface 401a of the softened substrate, for example, foam sheet 401 as exemplarily illustrated in FIG. 9A. In an embodiment as disclosed in the detailed description of FIGS. 3A-3B, the softened substrate, for example, foam sheet 401 with the affixed first laminate layer 408a is then conveyed to the material unwinder 411 using one or more of the conveyance rollers 403. The material unwinder 411 comprises pin rollers, for example, a first pin roller 411a and, a second pin roller 411b as exemplarily illustrated in FIG. 4B. The first pin roller 411a upwinds the substrate, for example, softened foam sheet 401 with the affixed first laminate layer 408a conveyed by the conveyance rollers 403, in communication with the smooth surface roller 407b and the patterned coat roller 406b. The first pin roller 411a winds the softened substrate, for example, foam sheet 401 with the affixed first laminate layer 408a up to a set length of, for example, about 450 yards. The upwound softened substrate, for example, foam sheet 401 with the affixed first laminate layer 408a is then removed from the first pin roller 411a and placed on the material unwinder 402 exemplarily illustrated in FIG. 4A, to allow application of a low viscosity, hot melt adhesive 416b on the non-coated opposing surface 401b of the substrate, for example, softened foam sheet 401 with the affixed first fabric material layer 408a.

For applying a low viscosity, hot melt adhesive 416b on the non-coated opposing surface 401b of the softened substrate, for example, foam sheet 401, the softened substrate sheet 401 with the affixed first laminate layer 408a is reversed to expose the non-coated opposing surface 401b of the substrate, for example, softened foam sheet 401. The reversed substrate sheet 401 with the exposed non-coated opposing surface 401b of the substrate sheet 401 is then transferred to the material unwinder 402 as exemplarily illustrated in FIG. 4A, and conveyed by one or more of the conveyance rollers 403 to the alignment rollers 404. The alignment rollers 404 align the reversed substrate sheet 401 and convey the reversed substrate sheet 401 to the adhesive dispenser 405, the pattern coat roller 406a, and the smooth surface roller 407a using one or more of the conveyance rollers 403. The adhesive dispenser 405, in communication with the patterned coat roller 406a and the smooth surface roller 407a, applies a uniform dispersion of the low viscosity, hot melt adhesive 416b on the exposed non-coated opposing surface 401b of the reversed substrate sheet 401, softens, and creates an imprinted pattern on the softened substrate sheet 401 for increasing absorption of the low viscosity, hot melt adhesive 416b into the softened substrate sheet 401 and to preclude creep of the low viscosity, hot melt adhesive 416b out of the softened substrate, for example, foam sheet 401 when the softened substrate sheet 401 sandwiched between the first laminate layer 408a and the second laminate layer 408b is conveyed through the rapid curing chamber 412.

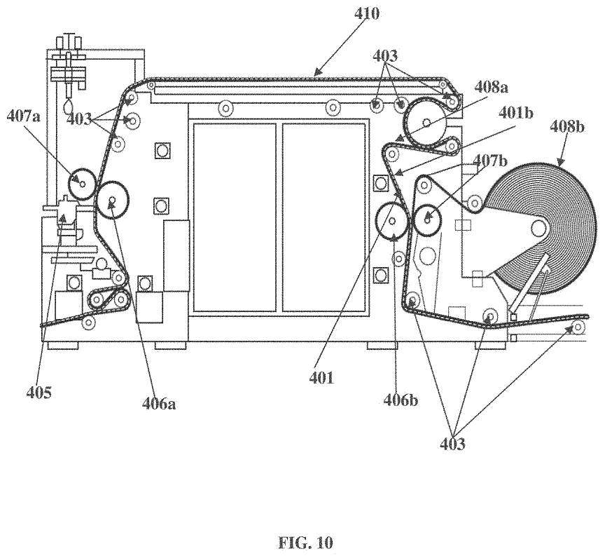

One or more of the conveyance rollers 403 convey the softened substrate, for example, foam sheet 401 with the coated opposing surface 401b of the softened foam sheet 401 towards the smooth surface roller 407b and the patterned coat roller 406b. The smooth surface roller 407b and the patterned coat roller 406b, in communication with one or more of the conveyance rollers 403, roll and press a second laminate layer 408b on the coated opposing surface 401b of the reversed substrate sheet, for example, foam sheet 401 through the second route 410 within the lamination system 400 to affix the second, laminate layer 408b to the coated opposing surface 401b of the reversed substrate sheet, for example, foam sheet 401 as exemplarily illustrated in FIGS. 10-12. The first laminate layer 408a and the second laminate material layer 408b are sequentially applied on opposing surfaces 401a and 401b of the substrate sheet 401 to sandwich the substrate, for example, foam sheet 401 between the first laminate layer 408a and the second laminate layer 408b as exemplarily illustrated in FIGS. 11A-11B. The substrate, for example, foam sheet 401 sandwiched between the affixed first laminate layer 408a and the affixed second laminate layer 408b is then conveyed to the material unwinder 411 exemplarily illustrated in FIG. 4B, using one or more of the conveyance rollers 403. The first pin roller 411a of the material unwinder 411 upwinds the substrate sheet 401 sandwiched between the first laminate layer 408a and the second laminate layer 408b and conveyed by the conveyance rollers 403. The first pin roller 411a winds the substrate sheet 401 sandwiched between the first laminate layer 408a and the second laminate layer 408b up to a set length of, for example, about 450 yards. A turret 411c turns positioning of the second pin, roller 411b of the material unwinder 411 to unwind the upwound sandwiched substrate sheet 401 onto the rapid curing chamber 412 containing the serpentine drape roller system 413.

The rapid curing chamber 412 comprises multiple high intensity ultraviolet lamps 412a, multiple cold cooling stations 412b, drainage ports 412c, and the serpentine drape roller system 413. One or more of the conveyance rollers 403 convey the substrate, for example, foam sheet 401 sandwiched between the affixed first laminate layer 408a and the affixed second laminate layer 408b through the rapid curing chamber 412 at a preset speed for full bonding and rapid curing of the sandwiched substrate, for example, foam sheet 401 exposed to the preset temperature, the preset humidity level, and the preset speed to provide the preset curing time in the rapid curing chamber 412. Based on the preset speed of conveyance of the substrate, for example, foam sheet 401 sandwiched between the affixed first laminate layer 408a and the affixed second laminate layer 408b, the rapid curing chamber 412 is set and maintained at a preset temperature and a preset humidity level, different from the incoming ambient temperature and ambient humidity to which the sandwiched substrate, for example, foam sheet 401, the first laminate layer 408a, and the second laminate layer 408b are exposed prior to entering the rapid curing chamber 412, using the high intensity ultraviolet lamps 412a and the cold cooling stations 412b of the rapid curing chamber 412 as disclosed in the detailed description of FIG. 1. The drainage ports 412c drain the moisture present in the rapid curing chamber 412. The high intensity ultraviolet, lamps 412a, the cold cooling stations 412b, the serpentine drape roller system 413, and the drainage ports 412c are synchronized, i.e., work in unison, and are controlled by electronics to coordinate speed, temperature, humidity and material drape flex tension in the rapid curing chamber 412. That is, when the speed of the rapid curing chamber 412 is reduced, the other parameters of the rapid curing chamber 412, for example, temperature, humidity, and the material drape flex tension are reduced. Similarly, when the speed of the rapid curing chamber 412 is increased, the other parameters of the rapid curing chamber 412 are increased to maintain consistent exposure of the in-process laminated product i.e. the sandwiched substrate, for example, foam sheet 401 to the preset humidity level and flex. The conveyed in-process laminated product, i.e., the substrate sheet 401 sandwiched between the affixed first laminate layer 408a and the affixed second laminate layer 408b is rapidly cured in the rapid curing chamber 412 through the reaction of the sandwiched substrate sheet 401 with the moisture in the rapid curing chamber 412 and the interaction of the heat created by the high intensity ultraviolet lamps 412a with the cold cooling stations 412b present within the rapid curing chamber 412.

In an embodiment as exemplarily illustrated in FIG. 4B, the serpentine drape roller system 413 comprises multiple guide rollers 413a positioned offset to each other for defining a non-linear path, for example, a serpentine path. The serpentine drape roller system 413 moves independently along a Y-axis for conveying, flexing, and stretching the conveyed substrate, for example, foam sheet 401 sandwiched between the affixed first laminate layer 408a and the affixed second laminate layer 408b to improve flexibility and draping properties of the extended foam laminate 415. The conveyed substrate sheet 401 sandwiched between the affixed first laminate layer 408a and the affixed second laminate layer 408b, within the serpentine drape roller system 413, is continuously bent as the in-process laminated product, i.e. the sandwiched substrate sheet 401 passes along the serpentine path to remove tension created on the sandwiched substrate sheet 401 to improve the flexibility and the draping properties of the extended foam laminate 415. The rapid curing chamber 412 rapidly cures the in-process laminated product, i.e. the sandwiched substrate sheet 401 exposed to the preset temperature, the preset humidity level, and the preset speed of conveyance of the in-process laminated product i.e., the preset cure time of about 4 to 6 minutes, to create an extended foam laminate 415 wherein the lamination process is free from emission of volatile organic compounds during the curing process and where the laminated product exhibits improved bond strength, flexibility, and draping properties.

In an embodiment, the softened substrate, for example, foam sheet 401 with one surface 401a of the conveyed substrate, for example, foam sheet 401 affixed with the first laminate layer 408a, is conveyed through the rapid curing chamber 412 comprising the serpentine drape roller system 413, prior to reversal of the softened substrate, for example, foam sheet 401 and application of the uniform dispersion of the low viscosity, hot melt adhesive 416b on the opposing surface 401b of the softened substrate 401, for example, foam sheet 401 as disclosed in the detailed description of FIGS. 2A-2B. After rapidly curing the softened substrate sheet 401 with the first laminate layer 408a affixed on one surface 401a of the conveyed substrate, for example, foam sheet 401, the cured substrate sheet 401 is reversed to expose a non-coated surface 401b of the cured substrate sheet 401 and the reversed substrate, for example, foam sheet 401 is conveyed from the material unwinder 402 to the alignment rollers 404 through the conveyance rollers 403, and thereafter to the adhesive dispenser 405, the patterned coat rollers 406a and 406b, and the smooth surface rollers 407a and 407b, and thereafter to the rapid curing chamber 412 to implement the steps 207, 208, 209, and 210 as disclosed in the detailed description of FIGS. 2A-2B.

The lamination system 400 disclosed herein improves the softness, flexibility, and draping properties of the extended foam laminate 415 during each of the coating and curing processes. The created extended foam laminate 415 with improved bond strength, flexibility, and draping properties can be used in the manufacture of automotive auxiliary items, for example, a seat, a door, overhead covers, instrument panels, carpeting, etc., as these items require a combination of good bond strength, good flexibility, and good draping properties.

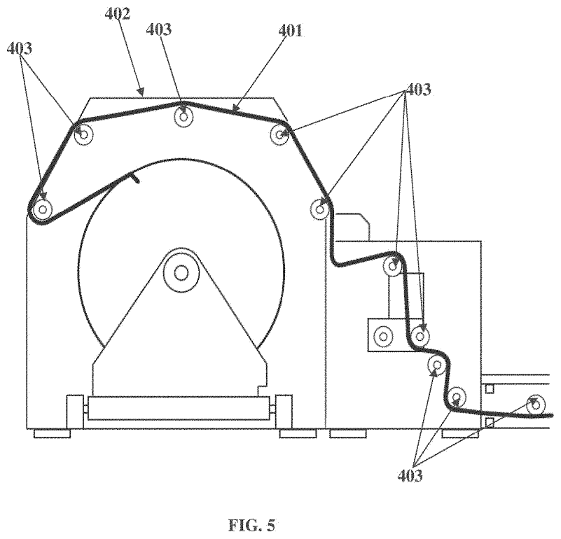

FIG. 5 exemplarily illustrates an enlarged view of a material unwinder 402 in the lamination system 400 for conveying a substrate, for example, a foam sheet 401 towards multiple alignment rollers 404 of the lamination system 400 exemplarily illustrated in FIGS. 4A-4B. The material unwinder 402 unwinds the substrate, for example, foam sheet 401 and conveys the substrate sheet 401 towards the alignment rollers 404 exemplarily illustrated in FIG. 6, using multiple conveyance rollers 403 as disclosed in the detailed description of FIGS. 4A-4B. In an embodiment as disclosed in the detailed description of FIGS. 2A-2B, the material unwinder 402 receives the cured and reversed laminated product 417 with the affixed first laminate layer 408a and unwinds and conveys the reversed in-process laminated product 417 shown in FIG. 9B towards the alignment rollers 404 using multiple conveyance rollers 403 as disclosed in the detailed description of FIGS. 4A-4B. In another embodiment as disclosed in the detailed description of FIGS. 3A-3B, the material unwinder 402 receives the reversed substrate, for example, foam sheet 401 with one surface 401a of the substrate, for example, foam sheet 401 affixed with the first laminate layer 408a exemplarily illustrated in FIG. 11B, prior to curing, and unwinds and conveys the reversed substrate, for example, foam sheet 401 towards the alignment rollers 404 using multiple conveyance rollers 403 as disclosed in the detailed description of FIGS. 4A-4B.

FIG. 6 exemplarily illustrates an enlarged view showing the alignment rollers 404 in the lamination system 400 exemplarily illustrated in FIGS. 4A-4B, for aligning the conveyed substrate, for example, foam sheet 401 to the adhesive dispenser 405, the patterned coat roller 406a, and the smooth surface roller 407a exemplarily illustrated in FIG. 7A, FIG. 7D, and FIG. 8. The alignment rollers 404 align the conveyed substrate, for example, foam sheet 401 and the softened foam sheet 401 affixed with the first laminate layer 408a to create tension on the conveyed substrate 401, for example, foam sheet 401 and the first laminate layer 408a, prior to the application of a low viscosity, hot melt adhesive 416a or 416b exemplarily illustrated in FIG. 7A, FIG. 7D, and FIG. 11B, on one or more surfaces 401a and 401b of the conveyed substrate, for example, foam sheet 401 exemplarily illustrated in FIG. 11B. The alignment rollers 404, in communication with the conveyance rollers 403, convey the aligned substrate, for example, foam sheet 401 to the patterned coat roller 406a and the smooth surface roller 407a.

FIG. 7A exemplarily illustrates an enlarged view of an embodiment of the patterned coat roller 406a, comprising a webbed pattern, for softening and creating an imprinted pattern on the conveyed substrate, for example, foam sheet 401 for increasing absorption of the low viscosity, hot melt adhesive 416a into the softened substrate, for example, foam sheet 401 and precluding creep of the low viscosity, hot melt adhesive 416a out of the softened substrate, for example, foam sheet 401. The adhesive dispenser 405, in communication with the patterned coat roller 406a and the smooth surface roller 407a, applies a uniform dispersion of, the low viscosity, hot melt adhesive 416a on, one surface 401a of the conveyed substrate, for example, foam sheet 401. The patterned coat roller 406a as exemplarily illustrated in FIG. 7A, is embedded with a pattern, for example, a webbed pattern 406c as exemplarily illustrated in FIG. 7B, to apply a uniform dispersion of the low viscosity, hot melt adhesive 416a on one surface 401a of the conveyed substrate, for example, foam sheet 401.

FIG. 7B exemplarily illustrates an enlarged view showing a webbed pattern 406c of the patterned coat roller 406a exemplarily illustrated in FIG. 7A. The patterned coat roller 406a with the webbed pattern 406c softens the conveyed substrate, for example, foam sheet 401 and creates an imprinted pattern, for example, a webbed pattern, on the conveyed substrate, for example, foam sheet 401 for increasing absorption of the low viscosity, hot melt adhesive 416a exemplarily illustrated in FIG. 7A, into the softened substrate, for example, foam sheet 401 and precluding creep of the low viscosity, hot melt adhesive 416a out of the conveyed substrate, for example, foam sheet 401 when the conveyed substrate, for example, foam sheet 401 with the affixed first laminate layer 408a, or in an embodiment, when the conveyed substrate, for example, foam sheet 401 sandwiched between the affixed first laminate layer 408a and the affixed second laminate layer 408b are conveyed through the rapid curing chamber 412 at relatively high speeds, for example, between about 25 meters per minute to about 60 meters per minute. Therefore, although a low viscosity, hot melt adhesive 416a is used, the weight of the low viscosity, hot melt adhesive 416a is distributed evenly on the surface 401a of the substrate, for example, foam sheet 401 exemplarily illustrated in FIG. 7A, by using the patterned coat roller 406a embedded with the webbed pattern 406c. That is, combined with the patterned coat roller 406a, the low viscosity, hot melt adhesive 416a is distributed over the surface 401a of the substrate, for example, foam sheet 401 in a uniform and consistent weight per gram distribution between the smooth surface roller 407a and the patterned coat roller 406a.

FIG. 7C exemplarily illustrates a photograph of the webbed pattern 406c imprinted on the conveyed substrate, for example, foam sheet 401 coated with hot melt adhesive 416a. As, exemplarily illustrated in FIG. 7C, white portions 406e in, the webbed pattern 406c imprinted on the conveyed substrate, for example, foam sheet 401 represent light reflected by hot melt adhesive 416a present on the conveyed substrate, for example, foam sheet 401. Dark portions of the webbed pattern 406c imprinted on the conveyed substrate, for example, foam sheet 401 represent dry portions of the webbed imprint 406c that do not have the hot melt adhesive 416a.

FIG. 7D exemplarily illustrates an enlarged view of another embodiment of the patterned coat roller 406a, comprising a hexagonal pattern 700. FIG. 7E exemplarily illustrates an enlarged view showing the hexagonal pattern 700 of the patterned coat roller 406a.

FIG. 7F exemplarily illustrates a photograph of the hexagonal pattern 700 imprinted on the conveyed substrate, for example, foam sheet 401 coated with hot melt adhesive 416a. As exemplarily illustrated in FIG. 7D, white portions 406e in the hexagonal pattern 700 imprinted on the conveyed substrate, for example, foam sheet 401 represent light reflected by hot melt adhesive 416a present on the conveyed substrate, for example, foam sheet 401. Dark portions of the hexagonal pattern 700 imprinted on the conveyed substrate, for example, foam sheet 401 represent dry portions of the hexagonal imprint 406c that do not have the hot melt adhesive 416a.

FIG. 8 exemplarily illustrates an enlarged view showing application of a first laminate layer 408a on one surface 401a of the conveyed substrate, for example, foam sheet 401. From the alignment rollers 404 exemplarily illustrated in FIG. 6, the substrate, for example, foam sheet 401 is conveyed to the patterned coat roller 406a and the smooth surface roller 407a as exemplarily illustrated in FIG. 8. The adhesive dispenser 405, in communication with the patterned coat roller 406a and the smooth surface roller 407a, applies a uniform dispersion of a low viscosity, hot melt adhesive 416a exemplarily illustrated in FIG. 7A and FIG. 11B, on one surface 401a of the conveyed substrate, for example, foam sheet 401. The smooth surface roller 407b and the patterned coat roller 406b roll and press a first laminate layer 408a on one surface 401a of the conveyed substrate, for example, foam sheet 401 through the first route 409 to affix the first laminate layer 408a to the conveyed substrate, for example, foam sheet 401 as disclosed in the detailed description of FIGS. 4A-4B.

FIG. 9A exemplarily illustrates an enlarged view of the conveyed substrate, for example, foam sheet 401 with the affixed first laminate layer 408a. The first laminate layer 408a, for example, a fabric layer is pressed on one surface 401a of the conveyed substi-ate, for example, foam sheet 401 by the smooth surface roller 407b and the patterned coat roller 406b as exemplarily illustrated in FIG. 8, to laminate one surface 401a of the conveyed substrate, for example, foam sheet 401 with the first laminate material layer 408a as disclosed in the detailed description of FIGS. 4A-4B.

FIG. 9B exemplarily illustrates a cross-sectional view of a laminated product 417 comprising the substrate, for example, foam sheet 401 with the affixed first laminate layer 408a. In the embodiment comprising two stages of rapid curing, the laminated product 417 created after rapidly curing the substrate, for example, foam sheet 401 with the first laminate layer 408a affixed to one surface 401a of the substrate, for example, foam sheet 401 is exemplarily illustrated in FIG. 9B. This laminate product 417 is then reversed to expose the non-coated opposing surface 401b of the laminated product 417 with the process flow proceeding with steps 207, 208, 209, and 210 as disclosed in the detailed description of FIGS. 2A-2B.

FIG. 10 exemplarily illustrates an enlarged view showing application of a second laminate layer 408b on a coated opposing surface 401b of a reversed substrate, for example, foam sheet 401. After affixing the first laminate layer 408a to one surface 401a of the substrate, for example, foam sheet 401, the substrate, for example, foam sheet 401 is reversed to expose the non-coated opposing surface 401b of the substrate, for example, foam sheet 401. The exposed non-coated opposing surface 401b of the reversed substrate, for example, foam sheet 401 is then coated with the low viscosity, hot melt adhesive 416b exemplarily illustrated in FIG. 11B, using the adhesive dispenser 405, the patterned coat roller 406a, and the smooth surface roller 407a. The reversed substrate, for example, foam sheet 401 is, then conveyed to the second route 410 within the lamination system 400 exemplarily illustrated in FIGS. 4A-4B. The smooth surface roller 407b and the patterned coat roller 406b roll and press a second laminate layer 408b on the exposed, coated opposing surface 401b of the reversed substi-ate, for example, foam sheet 401 through the second route 410 to create the substrate, for example, foam sheet 401 sandwiched between the affixed first laminate layer 408a and the affixed second laminate layer 408b as disclosed in the detailed description of FIGS. 4A-4B.

FIG. 11A exemplarily illustrates an enlarged view of the conveyed substrate, for example, foam sheet 401 sandwiched between the affixed first laminate layer 408a and the affixed second laminate layer 408b. The sandwiched substrate, for example, foam sheet 401 comprises the first laminate layer 408a and the second laminate layer 408b positioned on opposing surfaces 401a and 401b of the foam sheet 401 respectively as exemplarily illustrated in FIG. 11A.

FIG. 11B exemplarily illustrates a cross-sectional view of the extended foam laminated product 415 comprising the substrate, for example, foam sheet 401 sandwiched between the affixed first laminate layer 408a and the affixed second laminate layer 408b. The extended foam laminate 415 comprises the following layers bonded at the interface of each layer as exemplarily illustrated in FIG. 11B: a first laminate layer 408a on top, a first layer of a low viscosity, hot melt adhesive 416a below the first laminate layer 408a, a substrate, for example, foam sheet 401 below the first layer of the low viscosity, hot melt adhesive 416a, a second layer of a low viscosity, hot melt adhesive 416b below the substrate, for example, foam sheet 401, and the second laminate layer 408b at the bottom.

The first layer of the low viscosity, hot melt adhesive 416a is coated on the upper surface 401a of the substrate, for example, foam sheet 401, and the first laminate layer 408a is applied and bonded to the first layer of the low viscosity, hot melt adhesive 416a. The second layer of the low viscosity, hot melt adhesive 416b is coated on the lower surface 401b of the substrate, for example, foam sheet 401, and the second fabric laminate layer 408b is applied and bonded to the second layer of the low viscosity, hot melt adhesive 416b.

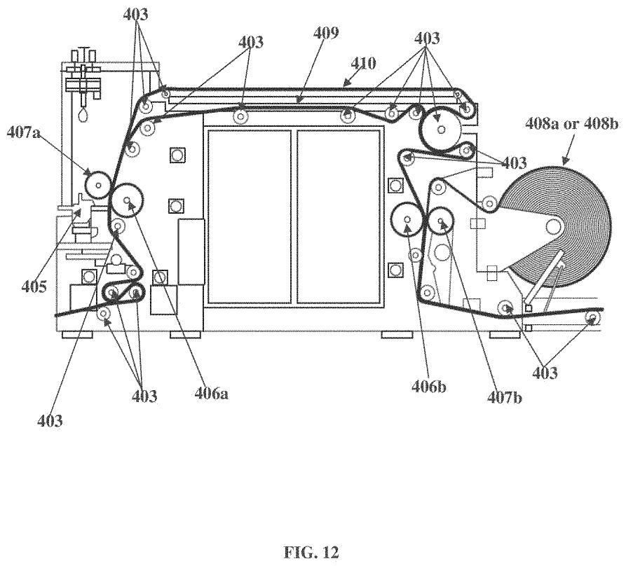

FIG. 12 exemplarily illustrates an enlarged view showing a first route 409 and a second route 410 within the lamination system 400 exemplarily illustrated in FIGS. 4A-4B, for sandwiching the conveyed substrate, for example, foam sheet 401 between the first laminate layer 408a and the second laminate layer 408b. In the first route 409, the smooth surface roller 407b and the patterned coat roller 406b roll and press the first laminate layer 408a on the low viscosity, hot melt adhesive coated surface 401a of the foam sheet 401 416a exemplarily illustrated in FIG. 7A and FIG. 7D, as disclosed in the detailed description of FIGS. 4A-4B. In the second route 410, the smooth surface roller 407b and the patterned coat roller 406b roll and press the second laminate layer 408a on the low viscosity, hot melt adhesive coated opposing surface 401b of the substrate, for example, foam sheet 401 exemplarily illustrated in FIG. 11B, to create the substrate, for example, foam sheet 401 sandwiched between the first laminate layer 408a and the second laminate layer 408b as disclosed in the detailed description of FIGS. 4A-4B.

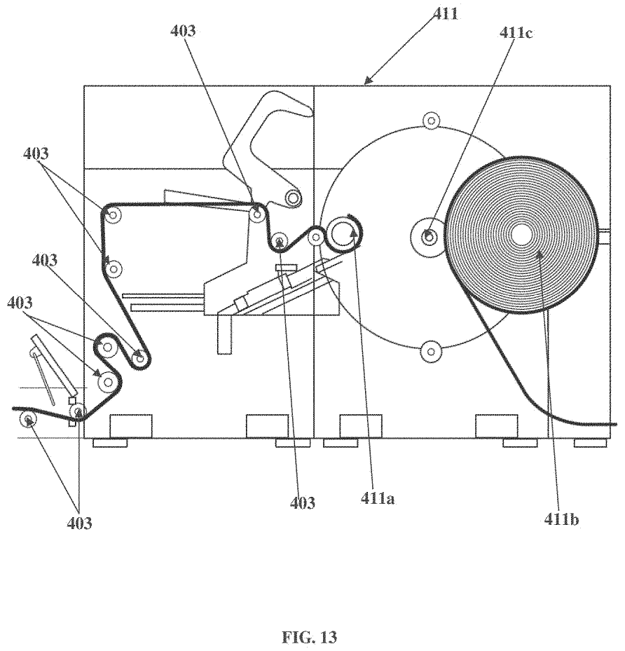

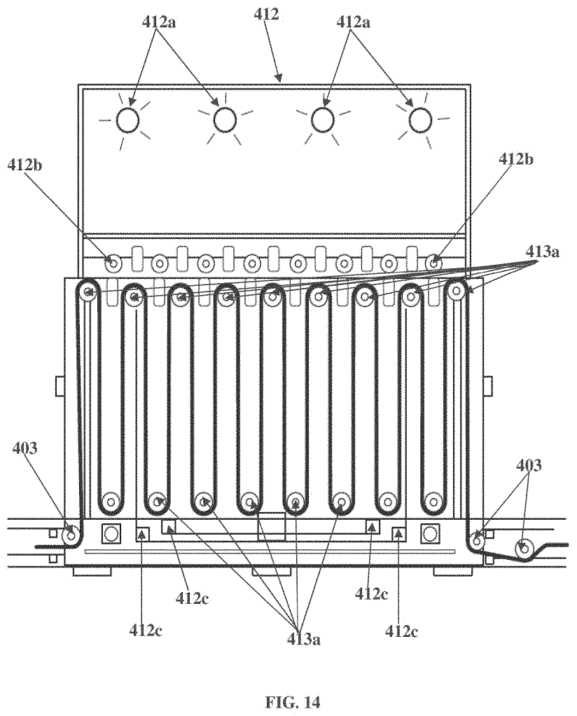

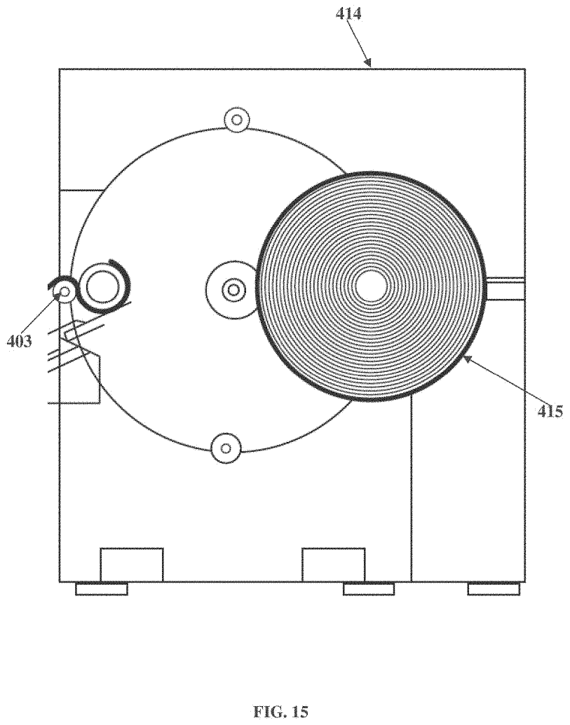

FIG. 13 exemplarily illustrates an enlarged view showing the material unwinder 411 in the lamination system 400 exemplarily illustrated in FIGS. 4A-4B, for unwinding the sandwiched substrate, for example, foam sheet 401 to the serpentine drape roller system 413 exemplarily illustrated in FIG. 14, contained within the rapid curing chamber 412 of the lamination system 400. As exemplarily illustrated in FIG. 13, multiple conveyance rollers 403 convey the sandwiched substrate, for example, foam sheet 401 to the material unwinder 411. The first pin roller 411a of the material unwinder 411 upwinds the sandwiched substrate, for example, foam sheet 401 conveyed by the conveyance rollers 403 from the smooth surface roller 407b and the patterned coat roller 406b exemplarily illustrated in FIG. 12. The turret 411c turns and positions the second pin roller 411b of the material unwinder 411 to unwind the upwound sandwiched foam sheet 401 into the rapid curing chamber 412 exemplarily illustrated in FIG. 14.

In an embodiment as disclosed in the detailed description of FIGS. 2A-2B, the substrate, for example, foam sheet 401 with one surface 401a of the substrate, for example, foam sheet 401 affixed with the first laminate layer 408a exemplarily illustrated in FIG. 9B, is conveyed to the material unwinder 411 by multiple conveyance rollers 403. The first pin roller 411a unwinds the substrate, for example, foam sheet 401 conveyed by the conveyance rollers 403 from the smooth surface roller 407b and the patterned coat roller 406b. The turret 411c turns the second pin roller 411b to unwind the upwound substrate, for example, foam sheet 401 affixed with the first laminate layer 408a from the first pin roller 411a into the second pin roller 411b when the first pin roller 411a winds to a preset length as exemplarily illustrated in FIG. 13. The second pin roller 411b unwinds the upwound substrate, for example, foam sheet 401 onto the rapid curing chamber 412 for rapidly curing and bonding the first laminate layer 408a to the substrate, for example, foam sheet 401.

FIG. 14 exemplarily illustrates an enlarged view of the rapid curing chamber 412 comprising multiple high intensity ultraviolet lamps 412a, cold cooling stations 412b, drainage ports 412c, and the serpentine drape roller system 413 for rapidly curing the sandwiched substrate, for example, foam sheet 401. The high intensity ultraviolet lamps 412a are wired and controlled by mainframe computer drivers. The rapid curing chamber 412 receives the substrate, for example, foam sheet 401 sandwiched between the affixed first laminate layer 408a and the affixed second laminate layer 408b and conveyed through the rapid curing chamber 412 at a preset speed using the conveyance rollers 403 for full bonding of the sandwiched foam sheet 401. The high intensity ultraviolet lamps 412a and the cold cooling stations 412b set and maintain the rapid curing chamber 412 at a preset temperature and a preset humidity level based on speed, of conveyance of the sandwiched substrate, for example, foam sheet 401 as disclosed in the detailed description, of FIGS. 4A-4B.

The guide rollers 413a of the serpentine drape roller system 413 define, a serpentine path for passing the sandwiched substrate, for example, foam sheet 401 to improve the flexibility and draping properties of the sandwiched substrate, for example, foam sheet 401. The conveyed substrate, for example, foam sheet 401 sandwiched between the affixed first laminate layer 408a and the affixed second laminate layer 408b within the serpentine drape roller system 413 is continuously bent as the sandwiched foam sheet 401 passes through the serpentine path to, remove tension created on one or more surfaces 401a and 401b of the substrate, for example, foam sheet 401, the first laminate layer 408a, and the second laminate layer 408b to improve the draping properties of the created extended foam laminate 415 exemplarily illustrated in FIG. 11B.

The rapid curing chamber 412 maintains a preset humidity level and a preset temperature, thereby exposing the conveyed substrate, for example, foam sheet 401 sandwiched between the affixed first laminate layer 408a and the affixed second laminate layer 408b to the required stable relative humidity and temperature, allowing the sandwiched substrate, for example, foam sheet 401 to set and cure at the preset cure time from about 4 minutes to 6 minutes upon contact with the preset high temperature and preset humidity to create an extended foam laminate 415 where the lamination process is free from emission of volatile organic compounds and the laminated product exhibits improved bond strength, flexibility, and draping properties. The stable preset temperature in the rapid curing chamber 412 ensures a stable humidity level in the rapid curing chamber 412, as humidity is dependent on temperature. The higher the temperature, the more moisture the air can hold at a given temperature, which allows full bonding and rapid, cross linking of the low viscosity, hot melt adhesive 416a or 416b exemplarily illustrated in FIG. 7A, FIG. 7D, and FIG. 11B, on the sandwiched substrate, for example, foam sheet 401. The stable preset temperature and preset humidity level maintained by the rapid curing chamber 412 allows creation of a firm, strong and thereto set polymer on the extended foam laminate 415 when the extended foam laminate 415 exits the rapid curing chamber 412, thereby resulting in an extended foam laminate 415 with improved bond strength. The rapid curing chamber 412 allows the substrate, for example, foam sheet 401 sandwiched between the affixed first laminate layer 408a and the affixed second, laminate layer 408b and the low viscosity, hot melt adhesives 416a and 416b exemplarily illustrated in FIG. 7A, FIG. 7D, and FIG. 11B, to cure rapidly upon contact with the preset temperature and humidity in the rapid curing chamber 412. The drainage ports 412c positioned, for example, at a lower location of the rapid curing chamber 412 drains liquids, for example, water formed during curing.

The independently Y-axis moving serpentine drape roller system 413 exemplarily illustrated in FIG. 14, facilitates improvement of flexibility, softness and draping properties in the extended foam laminate 415 exemplarily illustrated in FIG. 14. As the sandwiched substrate, for example, foam sheet 401 passes through the independently Y-axis moving serpentine drape roller system 413, the serpentine drape roller system 413 applies tension and releases tension on the sandwiched substrate, for example, foam sheet 401 by elongating and releasing the sandwiched substrate, for example, foam sheet 401 continuously as the sandwiched substrate, for example, foam sheet 401 passes through the rapid curing chamber 412 to, the material upwinder 414 exemplarily illustrated in FIG. 15, thereby furthering the softening effects garnered by using the patterned coat roller 406a during the application of the low viscosity, hot melt adhesives 416a and 416b. The continuous stretching and flexing of the sandwiched substrate, for example, foam sheet 401 moving through the independently Y-axis moving serpentine drape roller system 413 removes any curl memory the sandwiched substrate, for example, foam sheet 401 may have had before and after the lamination process. The use of the patterned coat roller 406a and the independently Y-axis moving serpentine drape roller system 413 softens the sandwiched substrate, for example, foam sheet 401 and prevents the low viscosity, hot melt adhesives 416a and 416b from fully wetting or creep off the sandwiched foam sheet 401. The use of the low viscosity, hot melt adhesives 416a and 416b allows for increased crosslinking and less grams per square inch disbursement. The use of the rapid curing chamber 412 allows for rapid curing, for example, at a preset time from about 4 minutes to 6 minutes. The lamination system 400 is fully automated and, controlled by electronics and allows for speeds of, for example, up to 60 meters per minute as compared to 25 feet per minute for conventional lamination systems. Higher speeds call for substantially high ultraviolet lamp intensity which in turn creates a substantially high stable temperature in the rapid curing chamber 412.

By enclosing the bank of high intensity ultraviolet lamps 412a, a series of cold cooling stations 412b, an independently Y-axis moving serpentine drape roller system 413, and drainage ports 412c, the rapid curing chamber 412 controls, manages, and rapidly cures the sandwiched substrate. Because the low viscosity, hot melt adhesives 416a and 416b rapidly react to the controlled temperature and humidity level produced by the rapid curing chamber 412, the low viscosity, hot melt adhesives 416a and 416b are rapidly cured without producing the volatile organic compound byproducts.

In an embodiment as disclosed in the detailed description of FIGS. 2A-2B, the softened substrate, for example, foam sheet 401 with one surface 401a of the softened substrate, for example, foam sheet 401 affixed with the first laminate layer 408a exemplarily illustrated in FIG. 9B, is conveyed through the rapid curing chamber 412 for rapid curing, prior to the application of the uniform dispersion of, the low viscosity, hot melt adhesive 416b on the opposing surface 401b of the softened substrate, for example, foam sheet 401 exemplarily illustrated in FIG. 9B, as disclosed in the detailed description of FIGS. 4A-4B.

FIG. 15 exemplarily illustrates an enlarged view showing the material upwinder 414 in the lamination system 400 exemplarily illustrated in FIGS. 4A-4B, for collecting the rapidly cured foam laminate 415 free from emission of volatile organic compounds and with improved bond strength, flexibility, and draping properties. Multiple conveyance rollers 403 convey the manufactured extended foam laminate 415 from the rapid curing chamber 412 exemplarily illustrated in FIG. 14, to the material upwinder 414. As exemplarily illustrated in FIG. 15, the material upwinder 414 upwinds the created extended foam laminate 415 which can then be removed for shipment. In an embodiment, the rapidly cured substrate, for example, foam sheet 401 with one surface 401a of the substrate, for example, foam sheet 401 affixed with the first laminate layer 408a exemplarily illustrated in FIG. 9B, is conveyed from the rapid curing chamber 412 to the material upwinder 414. The upwound rapidly cured substrate, for example, foam sheet 401 is then removed from the material upwinder 414, reversed to expose the opposing surface 401b of the laminated substrate, for example, foam sheet 401 exemplarily illustrated in FIG. 9B, and conveyed to the material unwinder 402 exemplarily illustrated in FIG. 5, for further lamination as disclosed in the detailed description of FIGS. 2A-2B. The use of the patterned coat roller 406a exemplarily illustrated in FIG. 8, in the application of the low viscosity, hot melt adhesives 416a and 416b exemplarily illustrated in FIG. 7A, FIG. 7D, and FIG. 11B, and the independently Y-axis moving serpentine drape roller system 413 removes stiff and curl memory the fabric and foam have exhibited during their manufacturing, packaging and transportation processes.

Consider the following examples of making a laminated product using a low viscosity, hot melt adhesive:

### Example 1

A low viscosity, hot melt adhesive, hereafter LVHMA, with a viscosity of about 4000 centipoise was applied to the surface of a foam substrate to be coated, at the LVHMA hot melt flow temperature of about 70° C., at a surface coating of about 15 grams per square inch of the substrate. A fiber laminate was thereafter applied to the surface of the applied LVHMA and the foam substrate-LVHMA-fiber laminate was processed to affix foam substrate, LVHMA, and fiber laminate to one another as disclosed in the specification under the description for FIG. 1, FIG. 2 and/or FIG. 3, to yield an in-process laminated product. The in-process laminated product was conveyed through a cure chamber maintained at a preset temperature of about 70° C., and a preset humidity of about 20%, for a preset cure time of about 4 minutes, to achieve crosslinking of the thermoset high viscosity hot melt adhesive and effect the bonding of the foam laminate to the fiber substrate.

### Example 2

A low viscosity, hot melt adhesive with a viscosity, hereafter LVHMA, with a viscosity of about 7000 centipoise was applied to the surface of a foam substrate to be coated, at the LVHMA flow temperature of about 90° C., at a surface coating of about 25 grams per square inch of the foam substrate. A fiber laminate was thereafter applied to the surface of the applied LVHMA and the foam substrate-LVHMA-fiber laminate was, processed to affix foam substrate, LVHMA, and fiber laminate to one another as disclosed in the specification under the description for FIG. 1, FIG. 2 and/or FIG. 3. Thein-process laminated product was conveyed through a curing chamber maintained at a preset temperature of about 90° C., and a preset humidity of about 95%, for a preset cure time of about 6 minutes, to achieve crosslinking of the thermoset high viscosity hot melt adhesive and effect the bonding of, the foam laminate to the fiber substrate.

The foregoing examples have been provided merely for explanation and are in no way to be construed as limiting of the method and the lamination system 400 exemplarily illustrated in FIGS. 4A-4B, disclosed herein. While the method and the lamination system 400 have been described with reference to various embodiments, it is understood that the words, which have been used herein, are words of description and illustration, rather than words of limitation. Furthermore, although the method and the lamination system 400 have been described herein with reference to particular means, materials, and embodiments, the method and the lamination system 400 are not intended to be limited to the particulars disclosed herein; rather, the method and the lamination system 400 extend to all functionally equivalent structures, methods and uses, such as are within the scope of the appended claims. While multiple, embodiments are disclosed, it will be understood by those skilled in the art, having the benefit of the teachings of this specification, that the method and the lamination system 400 disclosed herein are capable of modifications and other embodiments may be effected and changes may be made thereto, without departing from the scope and, spirit of the method and the lamination system 400 disclosed herein.

I claim:

1. A method of curing a low viscosity, hot melt adhesive with a viscosity in a range of about 4000 cps to 7000 cps, said method comprising curing said low viscosity, hot melt adhesive at a preset temperature selected from a temperature range of about 70° C. to 90° C., at a preset, humidity selected from a humidity range of about 20% to 95% relative humidity range, and a preset cure time of about 4 to 6 minutes.

2. A method for manufacturing a laminated product, said method comprising:
applying a low viscosity, hot melt adhesive with a viscosity of about 4000 centipoises to about 7000 cenlipoises on a substrate to be coated, at a low viscosity hot melt adhesive application temperature selected from a temperature range of about 70° C. to about 121° C., said hot melt, adhesive applied on said substrate at a surface coating of about 15 grams per square inch to about 25 grams per square inch of said substrate to produce an in-process laminated product; and,
curing said in-process laminated product by conveying said in-process laminated product through a cure chamber maintained at a preset temperature selected from a temperature range of about 70° C. to about 90° C., at a preset humidity selected from a humidity range of about 20% to 95% relative humidity, and a preset cure time of about 4 to 6 minutes, to achieve said desired crosslinking of said thermoset high viscosity hot melt adhesive and effect said bonding of said laminate to said substrate.

3. A method for rapidly curing a low viscosity, hot melt adhesive coated on a substrate, said method comprising:
providing a lamination system comprising alignment rollers, an adhesive dispenser, patterned coat rollers, smooth surface rollers, conveyance rollers, and a rapid curing chamber, said rapid curing chamber comprising a plurality of high intensity ultraviolet lamps, cold cooling stations, and a serpentine drape roller system, wherein said serpentine drape roller system moves independently along a Y-axis;
conveying said substrate on said alignment rollers of said lamination system using one or more of said conveyance rollers;
applying a uniform dispersion of said low viscosity, hot melt adhesive on at least one surface of said conveyed substrate using said adhesive dispenser, one or more of said patterned coat rollers, and one or more of said smooth surface rollers of said lamination system to coat said at, least one surface of said conveyed substrate, wherein said one or more of said patterned coat rollers, in communication with said one or more of said smooth surface rollers, and soften said conveyed substrate and create an imprinted pattern on said softened substrate for increasing absorption of said low viscosity, hot melt adhesive into said laminated product and for precluding creep of said low viscosity, hot melt adhesive out of said coated substrate;
applying a laminate layer on said coated surface of said softened substrate using one or more of said smooth surface, rollers, one or more of said patterned coat rollers, and said one or more of said conveyance rollers of said lamination system to affix said laminate layer to said coated surface of said softened substrate;
conveying said softened substrate with said affixed laminate layer through said serpentine drape roller system contained within said rapid curing chamber of said lamination system at a preset speed using said one or more of said conveyance rollers, wherein based on said preset speed of said conveyance of said softened substrate with said affixed laminate layer, said rapid curing chamber is maintained at a preset temperature and a preset humidity level, using said high intensity ultraviolet lamps and said cold cooling stations in said rapid curing chamber; and
exposing said conveyed substrate with said affixed laminate layer to said preset temperature, said preset humidity level, and said preset curing time in said curing chamber to effect a rapid cure to create a laminated product wherein the curing process is substantially free from of volatile organic compound emissions during said curing.

4. The method of claim 3, wherein said substrate is one of a foam sheet and a fabric material layer, and wherein said fabric material layer is one of cloth, a knitted fabric, a woven fabric, a non-woven fabric, and a fiber bonded fabric.

5. The method of claim 3, further comprising:
reversing said created laminated product to expose a non-coated opposing surface of said created laminated product and conveying said reversed laminated product on said alignment rollers using one or more of said conveyance rollers;
applying a uniform dispersion of said low viscosity, hot melt adhesive on said exposed non-coated opposing surface of said reversed laminated product using said adhesive dispenser, one or more of said patterned coat rollers, and one or more of said smooth surface rollers to coat said exposed non-coated opposing surface of said reversed laminated product, wherein said one or more of said patterned coat rollers, in communication with said one or more of said smooth surface rollers, soften said reversed laminated product and create an imprinted pattern on said reversed laminated product for increasing absorption of said low viscosity, hot melt adhesive into said reversed laminated product and to preclude creep of said low viscosity, hot melt adhesive out of said reversed coated substrate;
applying a supplementary laminate layer on said coated opposing surface of said reversed laminated product using one or more of said smooth surface rollers, said one or more of said patterned coat rollers, and said one or more of said conveyance rollers to affix said supplementary laminate layer to said coated opposing surface of said reversed laminated product;
conveying said reversed laminated product with said affixed supplementary laminate layer through said serpentine drape roller system contained within said rapid curing chamber of said lamination system at a preset speed using said one or more of said conveyance rollers, wherein based on said preset speed of said conveyance of said reversed laminated product with said affixed supplementary material layer, said rapid curing, chamber is set and maintained at a preset temperature and a preset humidity level, using said high intensity ultraviolet lamps and said cold cooling stations of said rapid curing chamber; and
rapidly curing said conveyed laminated product with said affixed supplementary laminate layer exposed to said preset temperature, said preset humidity level, said preset speed and said preset curing time of about 4 minutes to 6 minutes in said rapid curing chamber to produce an extended foam laminate.

6. The method of claim 3, further comprising, prior to conveying said softened substrate with said affixed laminate layer through said serpentine drape roller system contained within said rapid curing chamber of said lamination system at said preset speed using said one or more of said conveyance rollers:
reversing said softened substrate with said affixed laminate layer to expose a non-coated opposing surface, of said, softened substrate and conveying said reversed substrate on said alignment rollers using one or more of said conveyance rollers;
applying a uniform dispersion of said low viscosity, hot melt adhesive on said exposed non-coated opposing surface of said reversed substrate using said adhesive dispenser, one or more of said patterned coat rollers, and one or more of said smooth surface rollers to coat said exposed non-coated opposing surface of said reversed substrate, wherein said one or more of said patterned coat rollers, in communication with said one or more of said smooth surface rollers, soften said reversed substrate and create an imprinted pattern on said softened substrate for increasing absorption of said low viscosity, hot melt adhesive into said softened substrate to preclude creep of said low viscosity, hot melt adhesive out of said softened substrate; and
applying a supplementary laminate layer on, said coated opposing surface of said softened substrate using one or more of said smooth surface rollers, said one or more of said patterned coat rollers, and said one or more of said conveyance rollers to affix said supplementary laminate layer to said coated opposing surface of said softened substrate, wherein said softened substrate with said affixed laminate layer on said coated surface of said softened substrate and said affixed laminate layer on said coated opposing surface of said softened substrate are conveyed through said serpentine drape roller system contained within said rapid curing chamber of said lamination system for said rapid curing.

7. The method of claim 3, wherein said low viscosity, hot melt adhesive is a low viscosity polyurethane reactive hot melt adhesive of about 5000 centipoises to about 7000 centipoises applied to said at least one surface of said substrate at about 79° C. to about 121° C.

8. The method of claim 3, wherein said patterned coat rollers comprise one of a webbed pattern, a triangular pattern, a rhomboidal pattern, a hexagonal pattern, and any combination thereof.

9. The method of claim 3, further comprising distributing said low viscosity, hot melt adhesive on said at least one surface of said conveyed substrate in a preset and consistent weight per gram distribution dependent on said laminate layer between said one or more of said smooth surface rollers and said one or more of said patterned coat rollers of said lamination system.

10. The method of claim 3, wherein said created imprinted pattern in said softened substrate comprises a plurality of channels that create a path of low resistance for allowing said low viscosity, hot melt adhesive to pass, thereby increasing said absorption of said low viscosity, hot melt adhesive into said softened substrate and to preclude creep of said low viscosity, hot melt adhesive from said softened substrate conveyed through said rapid curing chamber.

11. The method of claim 3, wherein said preset temperature of said rapid curing chamber is selected from a temperature range of about 70° C. to about 90° C.

12. The method of claim 3, wherein said preset humidity level of said rapid curing chamber is selected from a humidity range of about 20% to about 95% relative humidity.

13. The method of claim 3, wherein said preset speed of said conveyance of said substrate through said rapid curing chamber is set from about 25 meters per minute to about 60 meters per minute.

14. The method of claim 3, wherein said substrate and said laminate layer are sheets of about 50 yards to about 450 yards long.

15. A lamination system for rapidly curing a low viscosity, hot melt adhesive coated on a substrate, said lamination system comprising:
a material unwinder, in communication with one or more conveyance rollers, for conveying said substrate towards a plurality of alignment rollers of said lamination system, wherein said alignment rollers align said conveyed substrate and create tension in said conveyed substrate;
an adhesive dispenser, in communication with one or more patterned coat rollers and one or more smooth surface rollers, for applying a uniform dispersion of said low viscosity, hot melt adhesive on at least one surface of said conveyed substrate to coat said at least one surface of said conveyed substrate, wherein said one or more of said patterned coat rollers, in communication with said one or more smooth surface rollers, soften said conveyed substrate and create an imprinted pattern on said softened substrate for increasing absorption of said low viscosity, hot melt adhesive into said softened substrate and to preclude creep of said low viscosity, hot melt adhesive out of said softened substrate;
said one or more smooth surface rollers and said one or more patterned coat rollers, in communication with said one or more conveyance rollers, for applying a laminate layer on said coated surface of said softened substrate to affix said laminate layer to said coated surface of said softened substrate;
a rapid curing chamber comprising a plurality of high intensity ultraviolet lamps, cold cooling stations, and a serpentine drape roller system for receiving said softened substrate with said affixed laminate layer conveyed through said rapid curing chamber at a preset speed using said one or more conveyance rollers, wherein based on said preset speed of said conveyance of said softened substrate with said affixed laminate layer, said rapid curing chamber is set and maintained at a preset temperature and a preset humidity level different from ambient temperature and ambient humidity respectively to which said substrate and said laminate layer are exposed prior to entering said rapid curing chamber, using said high intensity ultraviolet lamps and said cold cooling stations in said rapid curing chamber; and
said rapid curing chamber for rapidly curing said conveyed substrate with said affixed laminate layer exposed to said preset temperature, said preset humidity level, and said preset speed in about 4 minutes to about 6 minutes to create a laminate free from emission of volatile organic compounds during said curing.

16. The lamination system of claim 15, wherein said substrate is one of a foam sheet and a fabric material layer, and wherein said fabric material layer is one of a foam sheet and a fabric material, and wherein said fabric material is one of cloth, a knitted fabric, a woven fabric, a non-woven fabric, and a fiber bonded fabric.

17. The lamination system of claim 15, wherein said created laminated product is reversed to expose a non-coated opposing surface of said created laminated product, and wherein:
said material unwinder, in communication with said one or more conveyance rollers, conveys said reversed laminated product towards said alignment rollers of said lamination system using said one or more of said conveyance rollers, wherein said alignment rollers align said conveyed laminated product and create tension in said conveyed laminate;
said adhesive dispenser, in communication with said one or more patterned coat rollers and said one or more smooth surface rollers, applies a uniform dispersion of said low viscosity, hot melt adhesive on said exposed non-coated opposing surface of said reversed laminated product to coat said exposed non-coated opposing surface of said reversed laminated product, wherein said one or more patterned coat rollers in communication with said one or more smooth surface rollers soften said reversed laminated product and create an imprinted pattern on said softened laminate for increasing absorption of said low viscosity, hot melt adhesive into said softened laminate and to preclude creep of said low viscosity, hot melt adhesive, out of said softened laminated product;
said one or more smooth surface rollers and said one or more patterned coat rollers, in communication with said one or more conveyance rollers, apply a supplementary laminate layer on said coated opposing surface of said softened laminated product to affix said supplementary laminate layer to said coated opposing surface of said softened laminated product;
said rapid curing chamber receives said softened laminated product with said affixed supplementary laminate layer conveyed through said rapid curing chamber at a preset speed using said one or more conveyance rollers, wherein based on said preset speed of said conveyance of said softened laminated product with said affixed supplementary laminate layer, said rapid curing chamber is set and maintained at a preset temperature and a preset, humidity level different from ambient temperature and ambient humidity respectively to which said softened laminated product and said supplementary laminate layer are exposed prior to entering said rapid curing chamber, using said high intensity ultraviolet lamps and said cold cooling stations in said rapid curing chamber; and
said rapid curing chamber rapidly cures said conveyed laminated product with said affixed supplementary laminate layer exposed to said preset temperature, said preset humidity level, and said preset speed in about 4 minutes to about 6 minutes to create an extended foam laminate free from emission of volatile organic compounds during said curing.

18. The lamination system of claim 15, wherein prior to conveying said softened substrate with said affixed laminate layer through said serpentine drape roller system contained within said rapid curing chamber of said lamination system at said preset speed using said one or more of said conveyance rollers, said softened substrate is reversed to expose a non-coated opposing surface of said softened substrate, and wherein:
said material unwinder, in communication with said one or more conveyance rollers, conveys said reversed substrate towards said alignment rollers of said lamination system using said one or more of said conveyance rollers, wherein said alignment rollers align said reversed substrate and create tension in said reversed substrate;
said adhesive dispenser, in communication with said one or more patterned coat rollers and said one or more smooth surface rollers, applies a uniform dispersion of said low viscosity, hot melt adhesive on said exposed non-coated opposing surface of said reversed substrate to coat said exposed non-coated opposing surface of said reversed substrate, wherein said one or more patterned coat rollers in communication with said one or more smooth surface rollers soften said reversed substrate and create an imprinted pattern on said softened substrate for increasing absorption of said low viscosity, hot melt adhesive into said softened substrate and preventing creeping of said low viscosity, hot melt adhesive out of said softened substrate;
said one or more smooth surface rollers and said one or more patterned coat rollers, in communication with said one or more conveyance rollers, apply a supplementary laminate layer on said coated opposing surface of said softened substrate to affix said supplementary laminate layer to said coated opposing surface of said softened substrate, wherein said softened substrate with said affixed laminate layer on said coated surface of said softened substrate and said affixed laminate material layer on said coated opposing surface of said softened substrate are conveyed through said serpentine drape roller system contained within said rapid curing chamber of said lamination system for said rapid curing.

19. The lamination system of claim 15, wherein said low viscosity, hot melt adhesive is a low viscosity polyurethane reactive hot melt adhesive of about 5000 centipoises to about 7000 centipoises applied to said at least one surface of said substrate at about 79° C. to about 121° C.

20. The lamination system of claim 15, wherein said one or more patterned coat rollers comprise one of a webbed pattern, a triangular pattern, a rhomboidal pattern, a hexagonal pattern, and any combination thereof.

21. The lamination system of claim 15, wherein said created imprinted pattern in said softened substrate comprises a plurality of channels that create a path of low resistance for allowing said low viscosity, hot melt adhesive to pass, thereby increasing said absorption of said low viscosity, hot melt adhesive into said softened substrate and preventing creeping of said low viscosity, hot melt adhesive from said softened substrate conveyed through said rapid curing chamber.

22. The lamination system of claim 15, wherein said serpentine drape roller system further comprises a plurality of guide rollers positioned offset to each other for defining a non-linear path, and wherein said serpentine drape roller system moves independently along a Y-axis for conveying, flexing, and stretching said conveyed substrate to improve flexibility and draping properties of said created laminate.

23. The lamination system of claim 15, wherein said preset temperature of said rapid curing chamber is selected from a temperature range of about 70° C. to about 90° C., and wherein said preset humidity level of said rapid curing chamber is selected from a humidity range of about 20% to about 95% relative humidity, and wherein said preset speed of said conveyance of said substrate through said rapid curing chamber is set from about 25 meters per minute to about 60 meters per minute.

24. A rapid curing chamber for rapidly curing a low viscosity, hot melt adhesive coated on a substrate, said rapid curing chamber comprising:
a plurality of high intensity ultraviolet lamps and cold cooling stations for setting and maintaining said rapid curing chamber at a preset temperature and a preset humidity level different from ambient temperature and ambient humidity respectively to which said substrate is exposed prior to entering said rapid curing chamber, based on speed of conveyance of said substrate;
drainage ports positioned at a lower location of said rapid curing chamber for draining liquids formed during said curing; and
a serpentine drape roller system moving independently along a Y-axis for receiving, flexing, and stretching said substrate coated with said low viscosity, hot melt adhesive on at least one surface of said substrate and conveyed through said rapid curing chamber at a preset speed using said one or more conveyance rollers, and for rapidly curing said conveyed substrate exposed to said preset temperature, said preset humidity level, and said preset speed in said rapid curing chamber in about 4 minutes to about 6 minutes to create a laminated product free from emission of volatile organic compounds during said curing.
